(19) United States
(12) Patent Application Publication
(10) Pub. No.: US 2023/0166556 A1
(43) Pub. Date: Jun. 1, 2023

(54) METHOD FOR PRODUCING A MULTILAYER BODY, AND A MULTILAYER BODY

(71) Applicants: LEONHARD KURZ Stiftung & Co. KG, Furth (DE); OVD Kinegram AG, Zug (CH)

(72) Inventors: Violetta Olszowka, Zirndorf (DE); Benjamin Hasse, Nürnberg (DE); Harald Walter, Horgen (CH)

(21) Appl. No.: 17/923,019

(22) PCT Filed: Apr. 29, 2021
(86) PCT No.: PCT/EP2021/061324

§ 371 Date: Nov. 3, 2022

(30) Foreign Application Priority Data
May 14, 2020 (DE) 10 2020 113 144.5

(51) Int. Cl. B42D 25/435; B42D 25/342; B42D 25/425

(52) U.S. Cl. CPC B42D 25/435; B42D 25/342; B42D 25/425

(57) ABSTRACT

Methods for producing a multilayer body (1), and a multilayer body (1). The method for producing a multilayer body includes: —providing a carrier layer (10); —applying a first replication varnish layer (11) to the carrier layer (10); —molding a plurality of microlenses (12) arranged in the form of a grid into the first replication varnish layer (11a); —applying at least one layer (14) to be structured to the side of the carrier layer (10) opposite the plurality of microlenses; —structuring the at least one layer (14) to be structured using a separate high-resolution mask (23) such that a plurality of microimages (15) arranged in the form of a grid are formed by removal in areas of the at least one layer (14) to be structured. A multilayer body (1) has a carrier layer (10) and a first replication varnish layer (11a), applied to the carrier layer (10), into which a plurality of microlenses (12) arranged in the form of a grid are molded, and with a plurality of microimages (15) arranged in the form of a grid arranged on the side of the carrier layer (10) opposite the plurality of microlenses (12) arranged in the form of a grid.

The invention relates to methods for producing a multilayer body, and a multilayer body.

To protect security documents against forgeries, they are often provided with security elements, which make it possible to check the authenticity of the security document and provide protection against an imitation of the security document. In this connection, it is known, for example from WO 2005/052650 A2, to use microlenses in combination with microimages which, when interacting, generate optically variable effects because of the moiré magnification effect. When such security elements are used on banknotes, however, there is the problem here of making the total thickness as thin as possible with at the same time visually attractive microimages.

The object of the invention now is to provide a method for producing an improved multilayer body, and an improved multilayer body which conveys an improved optically variable impression.

This object is achieved by a method for producing a multilayer body, in particular a multilayered security element for protecting security documents, wherein the method comprises the following steps, which are performed in particular in the following order:
providing a carrier layer;
applying a first replication varnish layer to the carrier layer;
molding a plurality of microlenses arranged in the form of a grid into the first replication varnish layer;
applying at least one layer to be structured to the side of the carrier layer opposite the plurality of microlenses arranged in the form of a grid;
structuring the at least one layer to be structured using a separate high-resolution mask such that a plurality of microimages arranged in the form of a grid are formed by removal in areas of the at least one layer to be structured.

This object is further achieved by a method for producing a multilayer body, in particular a multilayered security element for protecting security documents, wherein the method comprises the following steps, which are performed in particular in the following order:
providing a carrier layer;
applying a first replication varnish layer to the carrier layer;
molding a plurality of microlenses arranged in the form of a grid into the first replication varnish layer;
printing a control structure onto the side of the carrier layer opposite the plurality of microlenses arranged in the form of a grid by means of a first high-resolution digital printer;
detecting the control structure by means of a detection device from sides of the plurality of microlenses arranged in the form of a grid such that the control structure is detected by means of the detection device through the plurality of microlenses arranged in the form of a grid;
applying a printed layer in areas to the side of the carrier layer opposite the plurality of microlenses arranged in the form of a grid by means of a second high-resolution digital printer using the detected control structure such that a plurality of microimages arranged in the form of a grid are formed by the printed layer.

This object is further also achieved by a method for producing a multilayer body, in particular a multilayered security element for protecting security documents, wherein the method comprises the following steps, which are performed in particular in the following order:
providing a carrier layer;
applying a first replication varnish layer to the carrier layer;
molding a plurality of microlenses arranged in the form of a grid into the first replication varnish layer;
applying a second replication varnish layer to the side of the carrier layer opposite the plurality of microlenses arranged in the form of a grid;
molding a subwavelength plasmonic structure in areas into the second replication varnish layer such that a plurality of microimages arranged in the form of a grid are formed by the molded subwavelength plasmonic structure;
applying a metal layer to the second replication varnish layer.

Furthermore, this object is achieved by a multilayer body, in particular a multilayered security element for protecting security documents, with a carrier layer and a first replication varnish layer, applied to the carrier layer, into which a plurality of microlenses arranged in the form of a grid are molded, and with a plurality of microimages arranged in the form of a grid arranged on the side of the carrier layer opposite the plurality of microlenses arranged in the form of a grid, in particular wherein the plurality of microimages arranged in the form of a grid are arranged registered relative to the plurality of microlenses arranged in the form of a grid. Such a multilayer body is preferably produced according to one of the above methods, in particular according to a method according to one of claims 1 to 37.

It has been shown here that, through the method according to the invention for producing a multilayer body, and through the multilayer body according to the invention, a multilayer body is obtained with visually attractive microimages which, when interacting with the microlenses, generate an eye-catching movement and/or depth effect. Further, a multilayer body is obtained the, in particular multicolored, microimages of which have a very high resolution which, when interacting with the microlenses, which have a very small focal length to reduce the total thickness, generate an attractive optical effect.

By a separate high-resolution mask is meant here an exposure mask which is produced by means of electron-beam lithography and/or laser-beam lithography and is arranged on the multilayer body only temporarily, preferably during an exposure step. In particular, the separate high-resolution mask does not remain in the finished multilayer body.

The separate high-resolution mask is preferably a separate photomask, in particular a separate high-resolution photomask.

Here, by high-resolution is preferably meant that the exposure mask has structures smaller than 10 μm, preferably smaller than 5 μm, further preferably smaller than 2.5 μm, in particular wherein the structures are formed as areas of surface which are permeable and not permeable to the respective exposure radiation. In other words, the exposure mask has a resolution of less than 10 μm, preferably less than 5 μm, further preferably less than 2.5 μm. Thus, it is possible for the exposure mask to have structures or areas of surface with a smallest dimension of less than 10 μm, preferably less than 5 μm, further preferably less than 2.5 μm. The smallest dimension can be for example the smallest width, length, diameter, height or a similar smallest size.

By a subwavelength plasmonic structure is preferably meant here relief structures which are suitable for generating plasmon polaritons, in particular surface plasmons, when interacting with a metal layer. Surface plasmons are in particular surface waves in which the longitudinal electron oscillations are excited parallel to the surface of a metal, wherein in particular the resultant electric field intensity in the space above the metallic surface is increased.

Such subwavelength plasmonic structures are for example linear gratings, cross gratings or hexagonal gratings with a grating period of between 150 nm and 400 nm, preferably between 200 nm and 350 nm and further in particular with a grating depth of more than 150 nm, preferably more than 250 nm.

By microimages is preferably meant here complete motifs and also incomplete motifs, i.e. fragments of motifs. A motif can in particular be selected from or be a combination of image, symbol, logo, coat of arms, portrait and/or alphanumeric characters.

By registered or register or registration-accurate or register-accurate or registration accuracy or register accuracy is meant a positional accuracy of two or more layers relative to each other. The register accuracy is to range within a predefined tolerance which is to be as small as possible. At the same time, the register accuracy of several elements and/or layers relative to each other is an important feature in order to increase the process reliability. The positionally accurate positioning can be effected in particular by means of sensorily, preferably optically, detectable registration marks or register marks. These registration marks or register marks can either represent specific separate elements or areas or layers or themselves be part of the elements or areas or layers to be positioned.

Further advantageous designs of the invention are described in the dependent claims.

It is advantageous if the at least one layer to be structured applied in step d) and structured in step e) comprises or is a first photoresist layer, which in particular remains in the multilayer body produced.

It is further advantageous if the at least one layer to be structured applied in step d) and structured in step e) has one or more, in particular at least two, layers selected from the group: photoresist layer, colored varnish layer, metal layer.

In particular, it is possible for the at least one layer to be structured applied in step d) and structured in step e) to have one or more, in particular at least two, layers selected from the group: at least one first photoresist layer, at least one first colored varnish layer, at least one second colored varnish layer, a first metal layer, at least one layer made of a transparent dielectric, a thin film layer system.

Thus, it is possible for the at least one structured layer to be or comprise at least one photoresist layer and/or at least one colored varnish layer and/or at least one metal layer. Thus, it is further possible for the at least one structured layer to be or have at least one first photoresist layer and/or at least one first colored varnish layer and/or at least one second colored varnish layer and/or a first metal layer and/or at least one layer made of a transparent dielectric and/or a thin film layer system.

In particular, it is possible for the at least one structured layer to have one or more, in particular at least two, layers selected from the group: photoresist layer, colored varnish layer, metal layer, and/or for the at least one structured layer to have one or more, in particular at least two, layers selected from the group: at least one first photoresist layer, at least one first colored varnish layer, at least one second colored varnish layer, a first metal layer, at least one layer made of a transparent dielectric, a thin film layer system.

With respect to possible designs of these layers, reference is made here to the statements below.

It is also possible for the plurality of microimages arranged in the form of a grid to be formed of at least one structured layer, which is removed in areas such that the plurality of microimages arranged in the form of a grid are formed. It is possible here for the at least one structured layer to comprise or be at least one first photoresist layer.

Further preferably, the at least one first photoresist layer is dyed, in particular dyed with dyes and/or pigments and/or contains fluorescent substances and/or is formed transparent. Still further preferably, the at least one first photoresist layer is applied over the whole surface in particular in a layer thickness of between 0.5 μm and 1.5 μm. It is thus possible for the plurality of microimages arranged in the form of a grid to be formed of the at least one first photoresist layer. It has been shown here that a very thin multilayer body, which at the same time contains high-resolution microimages, can thus be produced.

A positive photoresist, the solubility of which in particular increases when activated by exposure to light, or a negative photoresist, the solubility of which in particular decreases when activated by exposure to light, is preferably used to form the at least one first photoresist layer.

In particular, a positive photoresist is characterized in that, when sufficiently exposed to light with a suitable wavelength, such as for example by means of UV radiation, this photoresist becomes soluble in a particular solvent, for example in acidic or basic aqueous solutions, in the exposed areas. In particular through an exposure to light using the separate high-resolution mask, dyed areas with defined shape and size, which preferably form the plurality of microimages arranged in the form of a grid, can therefore preferably be achieved.

A positive photoresist preferably comprises for example condensation polymers of m- and p-cresol and formaldehyde (novolac resin), diazonaphthoquinone derivative (DNQ) and solvent or solvent mixture, such as for example 1-methoxy-2-propyl acetate.

In particular, a negative photoresist is characterized in that, when sufficiently exposed to light with a suitable wavelength, such as for example by means of UV radiation, this varnish cures, and thereby becomes insoluble in a particular solvent, for example in acidic or basic aqueous solutions, in the exposed areas. In particular through an exposure to light using the separate high-resolution mask, dyed areas with defined shape and size, which preferably form the plurality of microimages arranged in the form of a grid, can therefore preferably be achieved.

A negative photoresist is preferably based on epoxy resins and contains low-molecular-weight organic compounds which have in particular more than one epoxide group per molecule. Further, epoxy resins based on bisphenol A and/or epoxidized phenol novolac, and/or resorcinol diglycidyl are preferably used to generate negative photoresists.

It is further possible for the at least one layer to be structured applied in step d) and structured in step e) to comprise at least one first colored varnish layer, which is applied to the at least one first photoresist layer in particular over the whole surface. It is further possible here for the at least one first colored varnish layer to be structured in step e) registration-accurately with the at least one first photoresist layer. In other words, it is possible for at least one structured layer further to comprise at least one first colored varnish layer, which is in particular applied to the at least one first photoresist layer on the side of the at least one first photoresist layer facing away from the plurality of microlenses arranged in the form of a grid and is structured registration-accurately with the at least one first photoresist layer.

By colored varnish layer is preferably meant here a functional layer which generates in particular a color impression detectable for an observer.

By color is preferably meant here a dyeing which, with respect to the transparency and/or clarity or the scattering power, preferably comprises dyed crystal clear transparent or dyed scattering transparent or also dyed opaque.

The color preferably occurs as an intrinsic color of a material and/or is arranged as an additional dyed layer as in front of a layer in the viewing direction, wherein the layer lying underneath it is in particular modified in terms of its colored appearance for an observer. Here, the color preferably appears optically constant or invariable in terms of its hue and/or its color saturation and/or in terms of its transparency from almost all, in particular from all, observation and/or illumination angles. It is further possible for the color itself to be optically variable, wherein in particular the hue and/or the color saturation and/or the transparency of the color changes when the observation and/or illumination angle changes.

Dyes and/or pigments are preferably suitable as coloring substances for colored varnish layers. Pigments are preferably insoluble, in particular practically insoluble, in the medium in which they are integrated. Dyes preferably dissolve during their use and in particular lose their crystalline and/or particulate structure. Possible classes of dyes are in particular basic dyes, liposoluble dyes or metal complex dyes. Possible classes of pigments are in particular organic and inorganic pigments. Pigments are preferably constructed from a material present in one piece and/or have complex structures, for example as a layer structure with a plurality of layers of different materials and/or for example as capsules of different materials, in particular with a core and a shell.

Here, the at least one first colored varnish layer is preferably a layer which, unlike the at least one first photoresist layer, is itself not able to be exposed to light or structured. Further preferably, the at least one first colored varnish layer is structured in the same step in which the at least one first photoresist layer is structured. Here, the at least one first colored varnish layer is still further preferably removed together with the at least one first photoresist layer.

It is hereby advantageously achieved that the at least one first colored varnish layer and the at least one first photoresist layer are structured registration-accurately with each other, in particular wherein the at least one first photoresist layer is arranged above the at least one first colored varnish layer when viewed from the side of the plurality of microlenses arranged in the form of a grid. Furthermore, it is hereby possible in particular, as will be explained below, to generate multicolored microimages if for example the at least one first photoresist layer is dyed and, together with the at least one first colored varnish layer, generates multicolored microimages and/or a mixed color.

Further, it is also possible for the at least one layer to be structured applied in step d) and structured in step e) to comprise or be at least one second colored varnish layer and/or at least one first metal layer and/or at least one layer made of a transparent dielectric and/or at least one thin film layer system, which in particular comprises a partially transparent metal layer, a dielectric spacing layer and an opaque metal layer, which is applied in particular over the whole surface before the application of the at least one first photoresist layer to the side of the carrier layer opposite the plurality of microlenses arranged in the form of a grid.

It is also advantageous here if the at least one second colored varnish layer and/or the at least one first metal layer and/or the at least one layer made of a transparent dielectric and/or the at least one thin film layer system, which in particular comprises a partially transparent metal layer, a dielectric spacing layer and an opaque metal layer, is structured in step e) registration-accurately with the at least one first photoresist layer.

Thus, it is further possible for the at least one structured layer further to comprise or be at least one second colored varnish layer and/or at least one first metal layer and/or at least one layer made of a transparent dielectric and/or at least one thin film layer system, which in particular comprises a partially transparent metal layer, a dielectric spacing layer and an opaque metal layer, which is or are arranged in particular on the side of the at least one first photoresist layer facing the plurality of microlenses arranged in the form of a grid and is arranged registration-accurately with the at least one first photoresist layer and/or are arranged registration-accurately with each other. In other words, it is possible for the at least one structured layer further to comprise or be at least one second colored varnish layer and/or at least one first metal layer and/or at least one layer made of a transparent dielectric and/or at least one thin film layer system, which is or are preferably arranged between the carrier layer and the at least one first photoresist layer and further preferably is or are applied to the carrier layer or is or are arranged thereon. Thus, it is further possible if these layers are arranged on the side of the carrier layer facing away from the plurality of microlenses arranged in the form of a grid and/or are applied in particular over the whole surface before the application of the at least one first photoresist layer to the side of the carrier layer opposite the plurality of microlenses arranged in the form of a grid.

It is hereby advantageously achieved that the at least one second colored varnish layer and/or the at least one first metal layer and/or the at least one layer made of a transparent dielectric and/or the at least one thin film layer system, which in particular comprises a partially transparent metal layer, a dielectric spacing layer and an opaque metal layer, and the at least one first photoresist layer are structured registration-accurately with each other, in particular wherein the at least one first photoresist layer is arranged underneath the at least one second colored varnish layer and/or the at least one first metal layer and/or the at least one layer made of a transparent dielectric and/or the at least one thin film layer system when viewed from the side of the plurality of microlenses arranged in the form of a grid.

The at least one first photoresist layer is preferably removed again in particular after step e). The layer thickness of the multilayer body can hereby be further reduced and, in particular depending on the chemical composition of the at least one first photoresist layer, the chemical and/or physical and/or mechanical stability of the multilayer body can also be increased.

The at least one first photoresist layer applied in step d) and structured in step e) advantageously contains UV-blocking additives. Thus, it is possible for the structured at least one first photoresist layer in the multilayer body further to contain UV-blocking additives, which in particular absorb light from the ultraviolet wavelength range, preferably from the wavelength range between 200 nm and 380 nm. Further preferably, such UV-blocking additives have no or only a very low absorption in the wavelength range visible to the human eye of from 380 nm to 780 nm.

Advantageously, the UV-blocking additives are for example benzotriazole derivatives, which are used in the corresponding layers in particular with a proportion by mass in a range of from approx. 3% to 5%. Suitable organic UV absorbers are sold for example under the trade name Tinuvine by BASF, Ludwigshafen, Germany.

It is further advantageous here if the method further comprises the following steps, which are carried out in particular after step e):
applying at least one second photoresist layer to the at least one first photoresist layer, in particular wherein the at least one second photoresist layer has an exposure principle that complements the at least one first photoresist layer and/or wherein the solubility of the at least one second photoresist layer is altered at a different exposure wavelength than in the case of the at least one first photoresist layer;
exposing the at least one second photoresist layer to light from the side of the carrier layer having the plurality of microlenses arranged in the form of a grid, in particular by means of an exposure light source;
structuring the at least one second photoresist layer, in particular such that the at least one second photoresist layer is arranged register-accurately next to the at least one first photoresist layer.

By a complementary exposure principle is meant here in particular the use of an exposure principle that counteracts the exposure principle of the at least one first photoresist layer. Thus, by a complementary exposure principle is preferably meant that a positive photoresist, the solubility of which in particular increases when activated by exposure to light, is used to form the at least one first photoresist layer and a negative photoresist, the solubility of which in particular decreases when activated by exposure to light, is used to form the at least one second photoresist layer, or vice versa.

It is hereby achieved that the at least one photoresist layer and the at least one second photoresist layer are arranged exactly registered relative to each other, in particular as the already structured at least one first photoresist layer acts as a mask for the structuring of the at least one second photoresist layer because of the UV-blocking additives. If for example the at least one first and the at least one second photoresist layer are dyed with different colors, these are then exactly registered relative to each other.

It is hereby possible for the multilayer body further to comprise at least one second photoresist layer, in particular wherein the at least one second photoresist layer has an exposure principle that complements the at least one first photoresist layer and/or wherein the solubility of the at least one second photoresist layer is alterable at a different exposure wavelength than in the case of the at least one first photoresist layer, and wherein the at least one second photoresist layer is arranged register-accurately next to the at least one first photoresist layer.

It is further expedient if the method further comprises the following steps, which are carried out in particular after step e):
applying at least one second metal layer to the at least one first photoresist layer;
applying at least one third photoresist layer to the at least one second metal layer;
exposing the at least one third photoresist layer to light from the side of the carrier layer having the plurality of microlenses arranged in the form of a grid, in particular by means of an exposure light source;
structuring the at least one third photoresist layer and the at least one second metal layer, in particular such that the at least one second metal layer is arranged registration-accurately with the at least one first and/or third photoresist layer.

The at least one third photoresist layer is then preferably removed again.

Further, it is possible for the photoresist layers, in particular the at least one first and/or second and third photoresist layer, to be resist layers, in particular photosensitive resist layers.

The exposure light source is preferably for example a UV lamp or UV LED.

Thus, it is also possible for the multilayer body further to comprise at least one second metal layer and/or at least one third photoresist layer, which is applied in particular to the at least one first photoresist layer on the side of the at least one first photoresist layer facing away from the plurality of microlenses in the form of a grid, and wherein the at least one second metal layer and/or the at least one third photoresist layer is arranged registration-accurately with the at least one first and/or third photoresist layer.

It is hereby advantageously achieved that the at least one second metal layer and/or the at least one first and/or third photoresist layer are structured registration-accurately with each other, in particular as the already structured at least one first photoresist layer acts as a mask for the structuring of the at least one third photoresist layer because of the UV-blocking additives.

It is further preferred if the at least one first and/or second and/or third photoresist layer is developed, in particular in step e).

It is also possible for the method further to comprise the following step:
removing the at least one first and/or second and/or third photoresist layer.

It further possible for a positive photoresist, the solubility of which in particular increases when activated by exposure to light, or a negative photoresist, the solubility of which in particular decreases when activated by exposure to light, also to be used to form the at least one second and/or third photoresist layer. With respect to the design of positive and negative photoresists, reference is made here to the above statements.

The layer thickness of the at least one first and/or second and/or third photoresist layer is advantageously less than 15 μm, preferably less than 5 μm.

Furthermore, it is advantageous that at least one third colored varnish layer and/or at least one partially transparent metal layer and/or at least one dielectric spacing layer is applied to the carrier layer before step d) in particular over the whole surface, preferably wherein the at least one third colored varnish layer and/or the at least one partially transparent metal layer and/or the at least one dielectric spacing layer is not structured in step e).

Thus, it is possible for the multilayer body further to comprise at least one third colored varnish layer and/or at least one partially transparent metal layer and/or at least one dielectric spacing layer, which is preferably applied to the carrier layer in particular over the whole surface and/or is further preferably arranged between the carrier layer and the at least one structured layer, in particular the at least one first photoresist layer, or the printed layer or the second replication varnish layer.

Thus, it is also possible for the multilayer body to comprise one or more colored varnish layers, preferably two or more colored varnish layers, further preferably the at least one third and/or the at least one fourth and/or the at least one fifth colored varnish layer. It is also further possible for the multilayer body further to comprise one or more photoresist layers, preferably two or more photoresist layers, further preferably the at least one first and/or the at least one second photoresist layer. Furthermore, it is also possible for the multilayer body further also to comprise one or more metal layers, preferably two or more metal layers, further preferably the at least one first and/or the at least one second and/or the at least one third metal layer.

Thus, it is possible for the method further to comprise at least one of the following steps:
applying one or more colored varnish layers, preferably the at least one third and/or fourth colored varnish layer, in particular to the carrier layer, preferably before step d), and/or to the at least one layer to be structured, preferably after step e);
applying one or more metal layers, preferably the at least one second and/or third metal layer, in particular to the at least one layer to be structured and/or to the at least one first photoresist layer, preferably after step e).

It is advantageous if the one or more colored varnish layers, preferably the two or more colored varnish layers, further preferably the at least one third and/or the at least one fourth and/or the at least one fifth colored varnish layer, have a total ink holdout dE from the at least one layer to be structured, in particular in the CIELAB color space, of from 50 to 270, preferably from 100 to 270, further preferably from 130 to 270.

It is further advantageous if, of the one or more colored varnish layers, preferably of the two or more colored varnish layers, further preferably of the at least one third and/or the at least one fourth and/or the at least one fifth colored varnish layer and the at least one layer to be structured, the layer that faces the first replication varnish layer has a darker color, in particular with a low lightness value L, and the layer that, when viewed from the side of the plurality of microlenses arranged in the form of a grid, is arranged behind has the lighter color, in particular with a higher lightness value L.

Thus, it is also advantageous if the one or more colored varnish layers, preferably the at least one third and/or fourth colored varnish layer, applied, preferably before step d) and/or after step e), further preferably to the carrier layer and/or to the at least one layer to be structured, have a total ink holdout dE from the at least one layer to be structured, in particular in the CIELAB color space, of from 50 to 270, preferably from 100 to 270, further preferably from 130 to 270.

It is further also advantageous if, of the one or more colored varnish layers, preferably the at least one third and/or fourth colored varnish layer, applied, preferably before step d) and/or after step e), further preferably to the carrier layer and/or to the at least one layer to be structured, and of the at least one layer to be structured, the layer that faces the first replication varnish layer has a darker color, in particular with a low lightness value L, and the layer that, when viewed from the side of the plurality of microlenses arranged in the form of a grid, is arranged behind has the lighter color, in particular with a higher lightness value L.

By color or chromaticity or single color or single chromaticity is meant in particular a color location in a color space. The color space can be in particular the CIELAB color space. The color space can also be the RGB color space (R=red; G=green; B=blue) or the CMYK color space (C=cyan; M=magenta; Y=yellow; K=black) or color spaces such as RAL, HKS or the Pantone® color space.

By a different or differing chromaticity or by color contrast is meant in particular a color distance dE between two color locations in a color space. The color space can in particular be the CIELAB color space. A different chromaticity that is sufficiently perceptible for the human eye preferably has a color distance dE in the CIELAB color space of at least 2, preferably dE of at least 3, particularly preferably dE of at least 5.

The color location, in particular in the CIELAB color space, is preferably usually determined with a colorimeter, such as for example the Datacolor 650 spectrophotometer.

The value of dE (also Delta E or ΔE) between the color locations (L*,a*,b*)ₚ and (L*,a*,b*)ᵥ is preferably calculated as a Euclidean distance:

ΔE_{p,v}=\sqrt{(Lₚ*−Lᵥ*)²+(aₚ*−aᵥ*)²+(bₚ*−bᵥ*)₂}

In particular, the lightness value L* is perpendicular to the color plane (a*,b*). The a-coordinate advantageously indicates the chroma and color intensity between green and red and the b-coordinate indicates the chroma and the color intensity between blue and yellow. In particular: the larger the positive a and b values and the smaller the negative a and b values, the more intense the hue. In particular, furthermore: if a=0 and b=0, there is an achromatic hue on the lightness axis. Advantageously, L* can adopt values between 0 and 100 and a and b can vary between −128 and +127.

It is also preferred that after step e) at least one fourth colored varnish layer and/or at least one third metal layer and/or at least one further replication varnish layer is applied to the at least one layer to be structured in particular over the whole surface, preferably wherein a relief structure is stamped into the further replication varnish layer at least in areas.

Thus, it is also possible for the multilayer body further to comprise at least one fourth colored varnish layer and/or at least one third metal layer and/or at least one further replication varnish layer, which is preferably applied over the whole surface and/or is further preferably arranged on or applied to the side of the at least one structured layer facing away from the carrier layer, in particular the at least one first photoresist layer, or the printed layer or the second replication varnish layer. Furthermore, it is also expedient here if a relief structure is stamped into the further replication varnish layer at least in areas.

It has been shown here that, through the application of further layers before and/or after step e), colored and/or metallic, in particular colored, microimages can be generated which bring about attractive optical effects. Furthermore, it is hereby further possible in particular, as will be explained below, to generate multicolored microimages if for example the at least one first photoresist layer is dyed and, together with the at least one third colored varnish layer which was applied before step e) and/or together with the at least one fourth colored varnish layer which was applied after step e), multicolored microimages and/or a mixed color is generated. It is also possible, in particular with layers which are applied after step e), to generate metallic and/or colored backgrounds.

The plurality of microimages arranged in the form of a grid are preferably arranged overlapping at least in areas with the plurality of microlenses arranged in the form of a grid to generate a first optically variable effect, in particular when viewed from the side of the plurality of microlenses arranged in the form of a grid.

It is further also possible for the plurality of microimages and microlenses arranged in the form of grids arranged overlapping at least in areas to overlap with the relief structure stamped into the further replication varnish layer at least in areas, to overlap with it completely or not to overlap with it.

The relief structure here is preferably a diffractive grating, a Kinegram® or hologram, a blazed grating, a binary grating, a multi-step phase grating, a linear grating, a cross grating, a hexagonal grating, an asymmetrical or symmetrical grating structure, a retroreflective structure, in particular a binary or continuous free-form surface, a diffractive or refractive macrostructure, in particular a lens structure or microprism structure, a microlens, a microprism, a zero-order diffraction structure, a moth-eye structure or anisotropic or isotropic matte structure, or a superimposition or combinations of two or more of the above-named relief structures.

The at least one first and/or second and/or third photoresist layer and/or the carrier layer is preferably dyed, in particular dyed with dyes and/or pigments. The dyes preferably generate a color from the RGB color space (R=red; G=green; B=blue) or the CMYK color space (C=cyan; M=magenta; Y=yellow; K=black). However, it is also possible for the dyes to generate a color from a special color space, such as for example the RAL, HKS or Pantone® color space. The dyes further preferably generate a color from the CIELAB color space.

Thus, it is possible for example for the at least one first and/or second and/or third photoresist layer to be dyed with Orasol dyes and/or Microlith color pigments and/or Luconyl.

It further makes sense if the at least one first and/or second and/or third photoresist layer contains fluorescent substances, which are excited in particular by means of UV radiation, preferably from the wavelength range between 200 nm and 380 nm.

It is further possible for the at least one first and/or second and/or third photoresist layer to be transparent, in particular for the at least one first and/or second and/or third photoresist layer to have a transmittance for visible light, preferably from the wavelength range between 380 nm and 780 nm, of more than 50%, preferably more than 70%, further preferably of more than 85%, still further preferably of more than 90%.

Furthermore, it is possible in particular through corresponding dyeing of the at least one first and/or second and/or third photoresist layer and/or of the at least one first and/or second and/or third and/or fourth colored varnish layer and/or of the carrier layer, to generate multicolored microimages, if for example the at least one first photoresist layer is dyed and, together with the at least one first colored varnish layer, generates multicolored microimages and/or a mixed color.

The colored varnish layers, in particular the at least one first and/or second and/or third and/or fourth colored varnish layer, preferably contain at least one binder, at least one additive and one or more fillers.

By binders is preferably meant here polymer-based systems and mixtures thereof, such as for example polyester, polyacrylate, polymethacrylate, polyurethane, polystyrene, polybutyrate, nitrocellulose, polyvinyl chlorides, ethylene vinyl acetates, copolymers thereof or similar polymers.

By additives is preferably meant here organic or inorganic substances which achieve the processing properties, for example during the application of a color layer in the above method or during use of the security element itself, a predetermined effect.

By fillers is preferably meant here all further materials added to a system, in particular a polymer-based system, such as for example silica, pigments, dyes, UV-blocking additives, tracers, in particular taggants, and/or similar materials.

It is further possible for the at least one first and/or second and/or third and/or fourth colored varnish layer to be used as a mask layer. For this purpose, these color layers preferably contain UV-blocking additives as filler and/or additive, which in particular absorb light from the ultraviolet wavelength range, preferably from the wavelength range between 200 nm and 380 nm. Further preferably, such UV-blocking additives have no or only a very low absorption in the wavelength range visible to the human eye of from 380 nm to 780 nm, in particular with the result that the other optical appearance for the human eye is not or is only very slightly influenced thereby.

It is further useful if the at least one first and/or second and/or third and/or fourth colored varnish layer is formed as a glazing colored varnish layer, in particular as a colored varnish layer that is shone through transparently or translucently.

The colors of the colored varnish layers, in particular of the at least one first and/or second and/or third and/or fourth colored varnish layer, are advantageously transparent or at least translucent, wherein the transmissivity preferably lies between 5% and 99%, in particular in the wavelength range visible to the human eye of from 380 nm to 780 nm, preferably in the partial range from 430 nm to 690 nm. In particular, optically variable effects of the optically variable structures arranged underneath the at least one first and/or second and/or third and/or fourth colored varnish layer from the observer's direction of view are detectable.

It is further possible for the colored varnish layers, in particular the at least one first and/or second and/or third and/or fourth colored varnish layer, to be formed and/or to consist of several different colors, wherein here these preferably also have areas with color mixing of a first and second color, which preferably form by means of overlapping and/or by halftoning of the colored varnish layers, in particular the at least one first and/or second and/or third and/or fourth colored varnish layer.

It is also possible for the color saturation of the colored varnish layers, in particular the at least one first and/or second and/or third and/or fourth colored varnish layer, to vary.

The colored varnish layers, in particular the at least one first and/or second and/or third and/or fourth colored varnish layer, preferably generate a color from the RGB color space (R=red; G=green; B=blue) or the CMYK color space (C=cyan; M=magenta; Y=yellow; K=black). However, it is also possible for the colored varnish layers, in particular the at least one first and/or second and/or third and/or fourth colored varnish layer, to generate a color from a special color space, such as for example the RAL, HKS or Pantone® color space. The colored varnish layers, in particular the at least one first and/or second and/or third and/or fourth colored varnish layer, further preferably generate a color from the CIELAB color space.

It is advantageous if the layer thickness of the color layers, in particular of the at least one first and/or second and/or third and/or fourth colored varnish layer, is between 0.1 μm and 10 μm, preferably between 0.1 μm and 5 μm.

The colored varnish layers, in particular the at least one first and/or second and/or third and/or fourth colored varnish layer, are advantageously formed by printing, in particular by means of offset printing and/or gravure printing and/or flexographic printing and/or inkjet printing.

In particular in order to achieve a sufficient contrast, the colors of the corresponding layers are preferably chosen as follows:

Preferably, of the layers selected from the group: at least one first photoresist layer, at least one second photoresist layer, at least one first colored varnish layer, at least one second colored varnish layer, at least one third colored varnish layer, at least one fourth colored varnish layer, at least one fifth colored varnish layer, at least one first metal layer, at least one second metal layer, at least one third metal layer, at least one layer made of a transparent dielectric, at least one thin film layer system, dyed carrier layer, the layer that faces the first replication varnish layer has a darker color, in particular with a low lightness value L, and the layer that, when viewed from the side of the plurality of microlenses arranged in the form of a grid, is arranged behind has the lighter color, in particular with a higher lightness value L.

It is further preferred if the layers selected from the group, in particular if at least two of the layers selected from the group: at least one first photoresist layer, at least one second photoresist layer, at least one first colored varnish layer, at least one second colored varnish layer, at least one third colored varnish layer, at least one fourth colored varnish layer, at least one fifth colored varnish layer, at least one first metal layer, at least one second metal layer, at least one third metal layer, at least one layer made of a transparent dielectric, at least one thin film layer system, dyed carrier layer have, in particular in each case, a total ink holdout dE from each other in the CIELAB color space of from 50 to 270, preferably from 100 to 270, further preferably from 130 to 270.

Thus, it is expedient if the at least one layer to be structured applied in step d) and structured in step e) or the at least one structured layer comprises at least two layers selected from the group: at least one first photoresist layer, at least one first colored varnish layer, at least one second colored varnish layer, at least one first metal layer, in particular wherein the at least two layers have in each case a total ink holdout dE from each other in the CIELAB color space of from 50 to 270, preferably from 100 to 270, further preferably from 130 to 270, and/or wherein, of the at least two layers, the layer that faces the first replication varnish layer has a darker color, in particular with a low lightness value L, and the layer that, when viewed from the side of the plurality of microlenses arranged in the form of a grid, is arranged behind has the lighter color, in particular with a higher lightness value L.

Thus, it is also expedient if the at least one layer to be structured applied in step d) and structured in step e) or the at least one structured layer comprises at least two layers selected from the group: one or more photoresist layers, one or more colored varnish layers, one or more metal layers, in particular wherein the at least two layers have in each case a total ink holdout dE from each other in the CIELAB color space of from 50 to 270, preferably from 100 to 270, further preferably from 130 to 270, and/or wherein, of the at least two layers, the layer that faces the first replication varnish layer has a darker color, in particular with a low lightness value L, and the layer that, when viewed from the side of the plurality of microlenses arranged in the form of a grid, is arranged behind has the lighter color, in particular with a higher lightness value L.

Thus, it is advantageous if at least two layers selected from the group: one or more photoresist layers, one or more colored varnish layers, one or more metal layers have, in particular in each case, a total ink holdout dE from each other in the CIELAB color space of from 50 to 270, preferably from 100 to 270, further preferably from 130 to 270, and/or if, of at least two layers selected from the group: one or more photoresist layers, one or more colored varnish layers, one or more metal layers, the layer that faces the first replication varnish layer has a darker color, in particular with a low lightness value L, and the layer that, when viewed from the side of the plurality of microlenses arranged in the form of a grid, is arranged behind has the lighter color, in particular with a higher lightness value L.

In particular, a particularly good contrast is achieved hereby, which is preferably determined in the CIELAB color space by the total ink holdout dE. According to the CIELAB system the color space is in particular represented by a sphere, wherein this is defined by the three axes lightness L, red-green axis a and yellow-blue axis b. In particular, here, L=100 corresponds to white, L=0 corresponds to black and L=50 corresponds to the achromatic point. The total color distance dE is further determined as follows:

dE=((dL)²+(da)²+(db)²)^{1/2},

wherein in particular dL is the lightness difference, da is the color difference on the red-green axis and db is the color difference on the yellow-blue axis of two colors.

By contrast is preferably meant here the total color distance dE.

Expediently, the method further comprises at least one of the following steps, which is carried out in particular before step e):
generating the separate high-resolution mask by means of electron-beam lithography and/or by means of laser-beam lithography, in particular in a chromium-coated glass substrate;
contact-locking joining of the separate high-resolution mask with the at least one layer to be structured applied to the carrier layer.

Thus, it is preferred if the separate high-resolution mask comprises the following layers: a glass substrate, in particular made of high-purity quartz glass or calcium fluoride, a chromium layer, in particular an optically dense chromium layer, optionally an adhesion-promoter layer and optionally a pellicle.

By a pellicle is meant here in particular a thin, transparent membrane which covers the separate high-resolution mask. The pellicle preferably acts as a protective layer, which in particular protects the separate high-resolution mask from contamination. The pellicle is advantageously formed transparent and consists of a thin polymer material.

Further, it is expedient if step e) further comprises at least one of the following steps:
exposing the at least one layer to be structured to light from the side of the carrier layer opposite the plurality of microlenses arranged in the form of a grid, preferably by means of an exposure light source, through the separate high-resolution mask, in particular in a step-and-repeat method;
aligning the separate high-resolution mask, in particular by means of register marks, which preferably make an angular misalignment and/or a distortion detectable, wherein the angular misalignment is further preferably smaller than 0.5°, preferably smaller than 0.3°, further preferably smaller than 0.1°, still further preferably smaller than 0.05°.

Thus, it is advantageous if the plurality of microimages arranged in the form of a grid are further arranged substantially distortion-compensated and/or angular-misalignment-compensated relative to the plurality of microlenses arranged in the form of a grid, and/or if the angular misalignment between the plurality of microimages arranged in the form of a grid and the plurality of microlenses arranged in the form of a grid is smaller than 0.5°, preferably smaller than 0.3°, further preferably smaller than 0.1°, still further preferably smaller than 0.05°.

Furthermore, it is advantageous that a separate high-resolution mask with structures smaller than 10 μm, preferably smaller than 5 μm, further preferably smaller than 2.5 μm, is used in step e). Here, the structures are preferably formed of the chromium layer, in particular the optically dense chromium layer.

The plurality of microimages arranged in the form of a grid are preferably formed in step e) and/or step h) and/or step j) such that the plurality of microimages arranged in the form of a grid consist in each case of one or more pixels, wherein in particular the shortest edge length or the smallest diameter of a pixel is smaller than 10 μm, preferably smaller than 5 μm, particularly preferably smaller than 2.5 μm.

It is also advantageous if the plurality of microlenses arranged in the form of a grid have in each case a lens focal length of between 10 μm and 50 μm, preferably between 15 μm and 40 μm.

It is further expedient if the grid of the plurality of microlenses arranged in the form of a grid has a period of between 5 μm and 70 μm, preferably between 5 μm and 50 μm, further preferably between 10 μm and 40 μm, and/or if the plurality of microlenses arranged in the form of a grid have a lens diameter of between 5 μm and 70 μm, preferably between 5 μm and 50 μm, further preferably between 10 μm and 40 μm.

The plurality of microlenses arranged in the form of a grid preferably have a hemispherical geometry and/or a flattened hemispherical geometry and/or a geometry similar thereto.

It is also conceivable that the grid of the plurality of microlenses arranged in the form of a grid is a one- or two-dimensional grid. It is further conceivable that, in particular in the case of a two-dimensional grid, the microlenses are arranged offset line by line, preferably are offset by half a lens diameter and/or lens spacing.

It is further possible for the plurality of microlenses arranged in the form of a grid to be or have been molded over the whole surface or molded partially or in areas, in particular in step c). It is also possible for the plurality of microlenses arranged in the form of a grid to be molded or arranged with a different period, with a different lens diameter, a different geometry and/or a different lens focal length in areas. Furthermore, it is possible for the plurality of microlenses arranged in the form of a grid or the first replication varnish layer to be dyed and/or to be differently dyed.

The first and/or second and/or the further replication varnish layer is preferably a functional layer into which structures, in particular surface structures, are introduced and/or fixed, preferably by means of thermal replication and/or UV replication. Thus, it makes sense if the plurality of microlenses arranged in the form of a grid are molded into the first replication varnish layer in step c) by means of thermoplastic molding or UV molding.

It is further possible for the first and/or second and/or the further replication varnish layer to be a hybrid replication varnish layer which is for example thermally replicated and then cured by means of radiation, in particular by means of UV radiation and/or by means of electron radiation. In particular in the case of UV molding, the replication varnish layer is replicated at room temperature and then cured by means of UV radiation.

It is expedient if the first replication varnish layer is applied in step b) with an application weight of between 5 g/m² and 10 g/m².

It is further preferred if the layer thickness of the first and/or second and/or further replication varnish layer lies between 0.1 μm and 50 μm, preferably between 0.1 μm and 30 μm, further preferably between 0.3 μm and 20 μm, still further preferably between 0.5 μm and 20 μm, moreover preferably between 0.5 μm and 10 μm.

It is further conceivable that the first replication varnish layer and/or the second replication varnish layer and/or the further replication varnish layer contains fluorescent substances, which are excited in particular by means of UV radiation, preferably from the wavelength range between 200 nm and 380 nm. It is hereby made possible in particular for visible light to be coupled out of the first and/or second and/or the further replication varnish layer in the case of irradiation with UV radiation.

The fluorescent substances are preferably perylene dyes, such as for example Lumogen F types, in particular Lumogen F Red 305, Lumogen F Yellow 170, Lumogen F Pink 285, Lumogen F Orange 240 or Lumogen F Yellow 083, from BASF, Ludwigshafen, Germany. It is further also possible for the fluorescent substances to be Phosphor S6, Uvitex OB/Tinopal OB, Uvitex FP, fluorescent orange, fluorescent yellow, fluorescent red, Lumilux red CD120, Lumilux yellow orange CD130, Lumilux effect sipi yellow, Lumilux green CD116 or FTX Series Laser Red Code FTX-3.

It is advantageous if the proportion of perylene dyes to binder is between 0.01% and 20%, preferably between 0.1% and 15%, further preferably between 0.2% and 10%, in particular wherein polyacrylates, polyurethanes, epoxides, polyesters, polyvinyl chlorides, rubber polymers, ethylene acrylic acid copolymers, ethylene vinyl acetates, polyvinyl acetates, styrene block copolymers, phenol formaldehyde resin adhesives, melamines, alkenes, allyl ether, vinyl acetate, alkyl vinyl ether, conjugated dienes, styrene, acrylates and/or copolymer resins or mixtures thereof are used as binder.

It is further advantageous if the plurality of microimages arranged in the form of a grid are formed of a printed layer, which is applied in areas such that the plurality of microimages arranged in the form of a grid are formed by the printed layer, in particular wherein the printed layer is applied by means of a high-resolution digital printer.

It is also expedient if the multilayer body has a control structure, which is applied in particular by means of a high-resolution digital printer and which is preferably applied to the side of the carrier layer opposite the plurality of microlenses arranged in the form of a grid.

The high-resolution digital printer, in particular the first and/or the second high-resolution digital printer, advantageously has a resolution of at least 6,000 dpi, preferably at least 12,000 dpi, further preferably of at least 24,000 dpi.

It further also makes sense if the detection device is an optical sensor, such as for example a CMOS sensor and/or CCD sensor.

It is further preferred that an angular misalignment and/or a distortion is further detected in step g) with reference to the control structure.

Here, it is further preferred if, with reference to the detected angular misalignment and/or the detected distortion, the plurality of microimages arranged in the form of a grid formed of the printed layer in step h) are applied registered relative to the plurality of microlenses arranged in the form of a grid, wherein the angular misalignment is further preferably smaller than 0.5°, preferably smaller than 0.3°, further preferably smaller than 0.1°, still further preferably smaller than 0.05°.

It is also possible if the method further comprises the following step, which is carried out in particular between steps g) and h):
compensating for the angular misalignment and/or the distortion such that the plurality of microimages arranged in the form of a grid formed of the printed layer in step h) are applied registered relative to the plurality of microlenses arranged in the form of a grid.

Furthermore, it is expedient that at least one fourth metal layer and/or at least one layer made of a transparent dielectric and/or at least one fifth colored varnish layer is applied to the printed layer after step h). A colored background or an increase in contrast is hereby achieved for example.

It is also advantageous if the multilayer body comprises a second replication varnish layer on the side of the carrier layer opposite the plurality of microlenses arranged in the form of a grid, wherein subwavelength plasmonic structures are molded into the second replication varnish layer such that the plurality of microimages arranged in the form of a grid are formed by the molded subwavelength structure, and wherein the multilayer body further comprises a metal layer, which is applied in particular directly to the side of the second replication varnish layer having the subwavelength plasmonic structures. Here, in particular either the microimages themselves or the background of the microimages can have the subwavelength plasmonic structures and the respectively other area can have mirror surfaces and/or non-plasmonic structures such as for example matte scattering structures. In other words, in particular the microimages themselves can have subwavelength plasmonic structures and the background of the microimages has a mirror surface and/or non-plasmonic structures such as for example matte scattering structures or else the microimages themselves preferably have a mirror surface and/or non-plasmonic structures such as for example matte scattering structures and the background of the microimages has subwavelength plasmonic structures.

Preferably, both the microimages and the background of the microimages have subwavelength plasmonic structures. Here, it has proved to be advantageous if the colors of the subwavelength plasmonic structures is a lighter hue, such as for example light magenta, and the other color is a darker hue, such as for example black or dark gray.

In step k) the metal layer is advantageously applied such that plasmonic colors are generated by an interaction of the subwavelength plasmonic structure molded into the second replication varnish layer and the metal layer.

The subwavelength plasmonic structure preferably comprises grating structures selected from the group two-dimensional gratings, cross gratings, hexagonal gratings. Such grating structures further preferably have a grating period of between 150 nm and 400 nm and further preferably between 200 nm and 350 nm, and a relief depth of between 50 nm and 400 nm and further preferably between 150 nm and 350 nm.

In a preferred embodiment, in a structuring method, for example by means of etching methods and/or washing methods and/or exposure methods known per se, the metal layer is only removed in the areas with the subwavelength plasmonic structures or only removed in the areas without these subwavelength structures. For example, for this purpose, structuring methods, such as are described in particular in WO 2006084686 A2, can also be used, in which, caused by a relief structure designed differently in areas, an exposure to light, differing corresponding to the areas of the relief structure, of a photosensitive layer or washing mask is effected and the metal layer is thereby removed in areas and preserved in areas corresponding to the differing exposure to light.

It is further conceivable that before step i) at least one color filter layer is applied to the carrier layer in particular over the whole surface, preferably applied to the side of the carrier layer opposite the plurality of microlenses arranged in the form of a grid.

The metal layers, in particular the at least one first and/or second and/or third and/or fourth metal layer and/or the metal layer, are expediently layers made of aluminum, silver, chromium, copper, tin, indium, gold, zinc or an alloy of the above-named metals.

The metal layer which is applied to the side of the second replication varnish layer having the subwavelength plasmonic structures is preferably a layer made of aluminum, silver, copper or an alloy of the above-named metals.

It is further also possible for the metal layers, in particular the at least one first and/or second and/or third and/or fourth metal layer and/or the metal layer, to be layers made of aluminum or silver blackened by oxidation, such as for example substoichiometric AlₓO_{y}.

The metal layers, in particular the at least one first and/or second and/or third and/or fourth metal layer and/or the metal layer, are advantageously formed by vapor deposition or sputtering.

It is further useful if the layer thickness of the metal layers, in particular the at least one first and/or second and/or third and/or fourth metal layer and/or the metal layer, lies between 3 nm and 300 nm, preferably between 5 nm and 100 nm.

It is further possible for the metal layers, in particular the at least one first and/or second and/or third and/or fourth metal layer and/or the metal layer, to act as metallic mirror layers or as semi-transparent absorber layers. The layer thickness of the metal layers for the function as metallic mirror layer is preferably more than 15 nm. In particular for the function as semi-transparent absorber layer the layer thickness of the metal layers is less than 15 nm.

It is also possible for the metal layers, in particular the at least one first and/or second and/or third and/or fourth metal layer and/or the metal layer, to be formed by application of metal-pigment-containing varnishes, wherein the layer thickness here preferably lies between 0.1 μm and 50 μm, further preferably between 1 μm and 20 μm.

The carrier layer is preferably a mono- or multilayered film, the one or more layers of which consist in particular of the following materials or combinations thereof: polyethylene terephthalate (PET), polypropylene (PP), polyethylene (PE), polyethylene naphthalate (PEN), polycarbonate (PC), polyvinyl chloride (PVC), poly-oxydiphenylene-pyromellitimide (Kapton) or other polyimides, polylactide (PLA), polymethyl methacrylate (PMMA) or acrylonitrile butadiene styrene (ABS).

The layer thickness of the carrier layer is preferably between 1 μm and 500 μm, further preferably between 6 μm and 75 μm, still further preferably between 12 μm and 50 μm.

In step a) a carrier layer pre-coated in particular on one or both sides with an adhesion-promoter layer is expediently provided.

It is further expedient if before step b) and/or if before step i) an adhesion-promoter layer is applied to the carrier layer, in particular wherein in step b) and/or in step i) the first and/or second replication varnish layer is then applied to the adhesion-promoter layer applied to the carrier layer.

Thus, it is possible for the multilayer body further to comprise at least one adhesion-promoter layer, in particular wherein the at least one adhesion-promoter layer is arranged between the carrier layer and the first and/or second replication varnish layer.

Preferably, the layer thickness of the adhesion-promoter layer is preferably between 0.01 μm and 15 μm, further preferably between 0.1 μm and 5 μm.

The adhesion-promoter layer advantageously consists of polyester, epoxide, polyurethane, acrylate and/or copolymer resins or mixtures thereof. It is further possible for the adhesion-promoter layer to be designed thermoplastic, UV-curable, as a hybrid variant (thermoplastic and UV-curable), as a cold glue or as a self-adhesive adhesion-promoter layer.

It further makes sense for the multilayer body further to comprise at least one primer layer, in particular wherein the at least one primer layer is applied to the side of the plurality of microimages arranged in the form of a grid facing away from the carrier layer. The primer layer advantageously forms the outermost layer of the multilayer body, which is in particular opposite the plurality of microlenses arranged in the form of a grid.

The at least one primer layer is preferably a thermally activatable layer, which further preferably has a layer thickness of between 0.3 μm and 25 μm and is preferably deposited over the whole surface. The primer layer can in particular be constructed monolayered or multilayered. Furthermore, the primer layer can preferably be constructed on an aqueous, solvent-containing or radiation-curing basis and/or combinations thereof.

The following can in particular be used as binder for the primer layer: polyacrylates, polyurethanes, epoxides, polyesters, polyvinyl chlorides, rubber polymers, ethylene acrylic acid copolymers, ethylene vinyl acetates, polyvinyl acetates, styrene block copolymers, phenol formaldehyde resin adhesives, melamines, alkenes, allyl ether, vinyl acetate, alkyl vinyl ether, conjugated dienes, styrene, acrylates and the mixtures of the above raw materials and their copolymers. In particular, water, aliphatic (benzine) hydrocarbons, cycloaliphatic hydrocarbons, terpene hydrocarbons, aromatic (benzene) hydrocarbons, chlorinated hydrocarbons, esters, ketones, alcohols, glycols, glycol ethers, glycol ether acetates can be used as solvents.

Furthermore, in particular, curing agents, crosslinkers, photoinitiators, fillers, stabilizers, inhibitors, additives such as e.g. flow additives, defoamers, deaerators, dispersing additives, wetting agents, lubricants, matting agents, rheology additives, pigments and dyes or waxes can be added to the primer layer.

The primer layer is preferably applied by means of a printing method such as e.g. gravure printing, screen printing, flexographic printing, inkjet printing, pouring or by means of a doctor-blade method.

It is possible for the method further to comprise the following step:
applying at least one edge emitter layer to the side of the carrier layer opposite the plurality of microlenses arranged in the form of a grid and/or to the plurality of microlenses arranged in the form of a grid, in particular to the side of the plurality of microlenses arranged in the form of a grid facing an observer. Thus, it is of course also possible for the multilayer body further to comprise at least one edge emitter layer, which is arranged on the side of the carrier layer opposite the plurality of microlenses arranged in the form of a grid and/or on the plurality of microlenses arranged in the form of a grid, in particular on the side of the plurality of microlenses arranged in the form of a grid facing an observer.

The at least one edge emitter layer is preferably a layer made of binders and auxiliary agents, for example additives, in particular wherein the edge emitter layer further preferably contains fluorescent substances. With respect to the binders and the fluorescent substances, reference is made here to the above statements.

In step e) and/or step h) and/or step j) the plurality of microimages arranged in the form of a grid are advantageously applied, molded, structured and/or formed registered relative to the plurality of microlenses arranged in the form of a grid.

It is further possible for the plurality of microimages arranged in the form of a grid to be formed in step e) by the areas in which the at least one layer to be structured is removed or is not removed, and/or for the plurality of microimages arranged in the form of a grid to be formed in step h) by the areas of the printed layer in which the printed layer is applied or is not applied, and/or for the plurality of microimages arranged in the form of a grid to be formed in step j) by the areas in which the subwavelength plasmonic structure is molded or is not molded.

It is further preferred if the total thickness of the multilayer body is smaller than 50 μm, preferably is smaller than 35 μm, still further preferably smaller than 25 μm.

Embodiment examples of the invention are explained below by way of example with the aid of the accompanying figures, which are not true to scale.

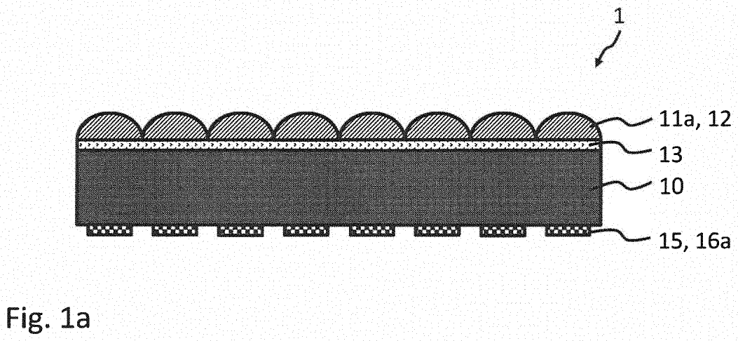

FIG. 1 a schematically shows a sectional representation of a multilayer body

FIG. 1b to FIG. 1d schematically show methods for producing a multilayer body

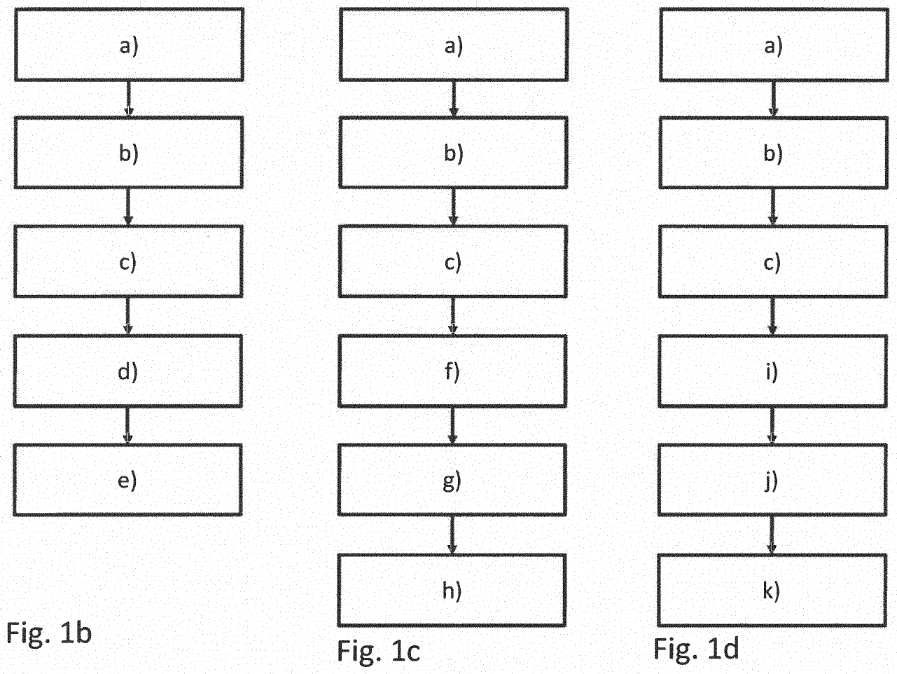

FIG. 2 schematically shows a method for generating a separate high-resolution mask

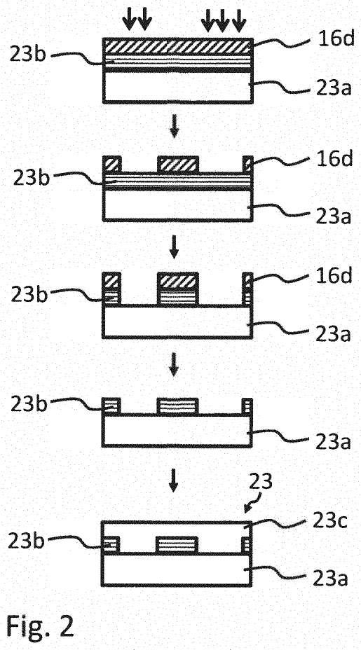

FIG. 3a to FIG. 3c show schematic sectional representations of multilayer bodies

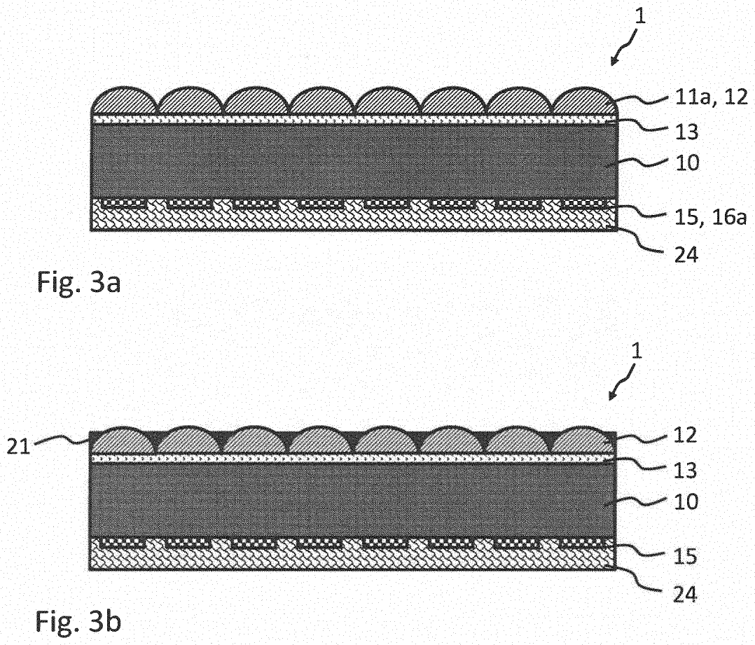

FIG. 4a and FIG. 4b show a method for producing a multilayer body, and a multilayer body

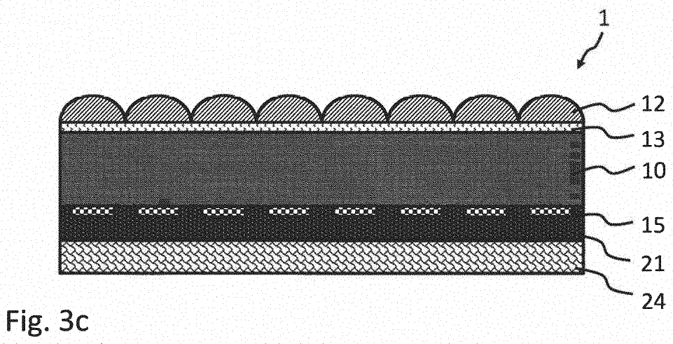

FIG. 5 schematically shows a sectional representation of a multilayer body

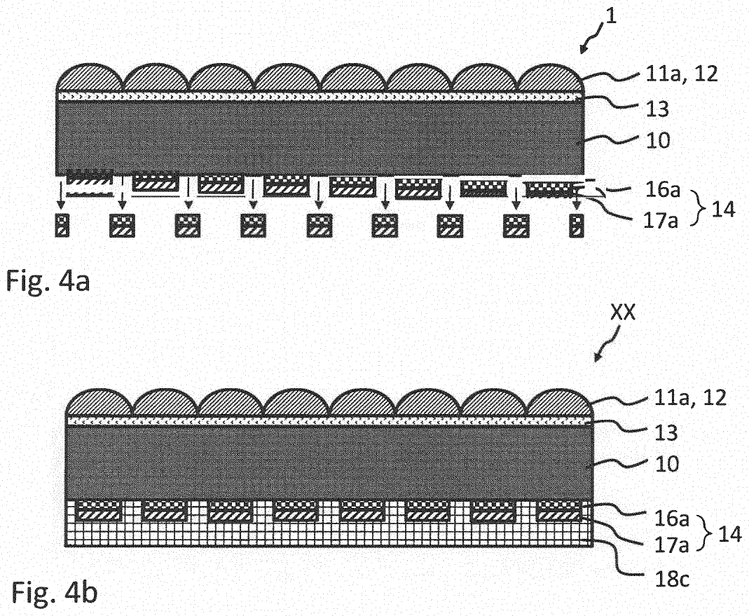

FIG. 6 schematically shows a representation of the CIELAB color space

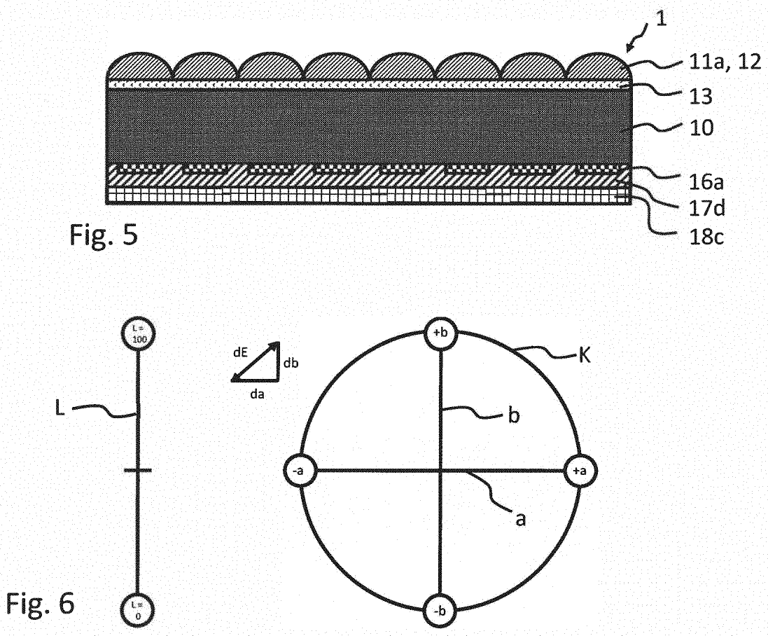

FIG. 7 to FIG. 10 schematically show sectional representations of multilayer bodies

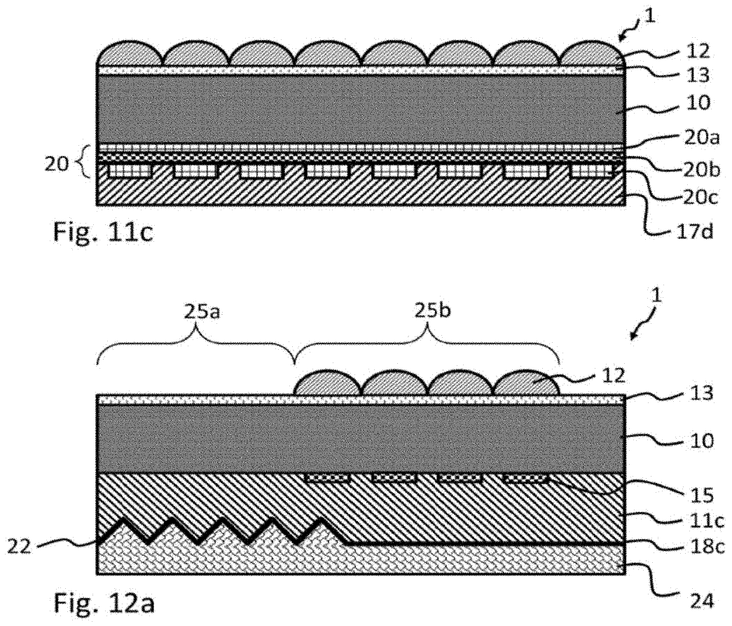

FIG. 11a to FIG. 11c schematically show sectional representations of multilayer bodies

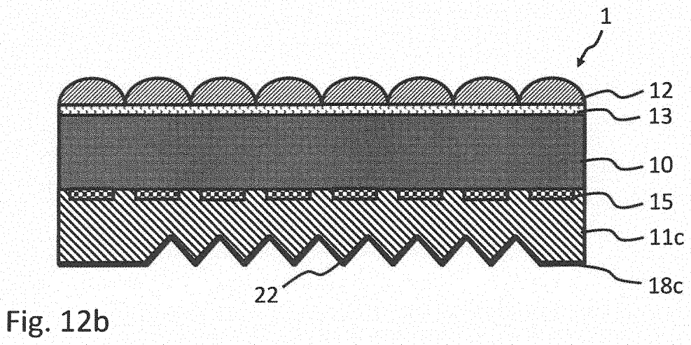

FIG. 12a and FIG. 12b schematically show sectional representations of multilayer bodies

FIG. 1a schematically shows a sectional representation of a multilayer body 1.

The multilayer body 1 is preferably a multilayered security element for protecting security documents.

The multilayer body, as shown in FIG. 1a, comprises a carrier layer 10 and a replication varnish layer 11a, applied to the carrier layer 10, into which a plurality of microlenses 12 arranged in the form of a grid are molded. The multilayer body further has a plurality of microimages 15 arranged in the form of a grid arranged on the side of the carrier layer 10 opposite the plurality of microlenses 12 arranged in the form of a grid, in particular wherein the plurality of microimages 15 arranged in the form of a grid are arranged registered relative to the plurality of microlenses 12 arranged in the form of a grid.

The carrier layer 10 is preferably a mono- or multilayered film, the one or more layers of which consist in particular of the following materials or combinations thereof: polyethylene terephthalate (PET), polypropylene (PP), polyethylene (PE), polyethylene naphthalate (PEN), polycarbonate (PC), polyvinyl chloride (PVC), poly-oxydiphenylene-pyromellitimide (Kapton) or other polyimides, polylactide (PLA), polymethyl methacrylate (PMMA) or acrylonitrile butadiene styrene (ABS).

The layer thickness of the carrier layer 10 is preferably between 1 μm and 500 μm, further preferably between 6 μm and 75 μm, still further preferably between 12 μm and 50 μm.

The carrier layer 10 shown in FIG. 1a is for example a carrier layer made of PET with a layer thickness of 12 μm. With respect to further possible designs of the carrier layer 10, reference is made here to the above statements.

Furthermore, the multilayer body 1 has an adhesion-promoter layer 13, which is arranged between the plurality of microlenses 12 arranged in the form of a grid and the carrier layer 10. For this purpose, a carrier layer 10 pre-coated on one side with the adhesion-promoter layer 13 is expediently provided.

Preferably, the layer thickness of the adhesion-promoter layer 13 is preferably between 0.01 μm and 15 μm, particularly preferably between 0.1 μm and 5 μm.

The adhesion-promoter layer 13 advantageously consists of polyester, epoxide, polyurethane, acrylate and/or copolymer resins or mixtures thereof. It is further possible for the adhesion-promoter layer to be designed thermoplastic, UV-curable, as a hybrid variant (thermoplastic and UV-curable), as a cold glue or as a self-adhesive adhesion-promoter layer.

The adhesion-promoter layer 13 shown in FIG. 1a is for example an adhesion-promoter layer made of epoxide with a layer thickness of 1 μm. With respect to further possible designs of the adhesion-promoter layer 13, reference is made here to the above statements.

The plurality of microlenses 12 arranged in the form of a grid are molded into the replication varnish layer 11a.

The replication varnish layer 11a is preferably a functional layer, into which structures, in particular surface structures, are introduced and/or fixed, preferably by means of thermal replication and/or UV replication.

It is further possible for the replication varnish layer 11a to be a hybrid replication varnish layer, which is for example thermally replicated and then cured by means of radiation, in particular by means of UV radiation and/or by means of at least one electron beam. In particular in the case of UV molding, the replication varnish layer 11a is replicated at room temperature and then cured by means of UV radiation.

It is further preferred if the layer thickness of the replication varnish layer 11a lies between 0.1 μm and 50 μm, preferably between 0.1 μm and 30 μm, further preferably between 0.3 μm and 20 μm, still further preferably between 0.5 μm and 20 μm, moreover preferably between 0.5 μm and 10 μm.

It is further conceivable that the replication varnish layer 11a contains fluorescent substances, which are excited in particular by means of UV radiation, preferably from the wavelength range between 200 nm and 380 nm.

The replication varnish layer 11a shown in FIG. 1a is for example a UV-curable layer, which has been applied in a layer thickness of 30 μm. With respect to further possible designs of the replication varnish layer 11a, reference is made here to the above statements.

It is also advantageous if the plurality of microlenses 12 arranged in the form of a grid in each case have a lens focal length of between 10 μm and 50 μm, preferably between 15 μm and 40 μm.

It is further expedient if the grid of the plurality of microlenses 12 arranged in the form of a grid has a period of between 5 μm and 70 μm, preferably between 5 μm and 50 μm, further preferably between 10 μm and 40 μm, and/or if the plurality of microlenses 12 arranged in the form of a grid have a lens diameter of between 5 μm and 70 μm, preferably between 5 μm and 50 μm, further preferably between 10 μm and 40 μm.

The plurality of microlenses 12 arranged in the form of a grid preferably have a hemispherical geometry and/or a flattened hemispherical geometry and/or a geometry similar thereto.

It is also conceivable that the grid of the plurality of microlenses 12 arranged in the form of a grid is a one- or two-dimensional grid. It is further conceivable that, in particular in the case of a two-dimensional grid, the microlenses 12 are arranged offset line by line, preferably are offset by half a lens diameter and/or lens spacing.

The plurality of microlenses 12 arranged in the form of a grid shown in FIG. 1a are for example flattened hemispherical microlenses with a lens diameter of in each case 25 μm and a lens focal length of 30 μm, which are arranged according to a two-dimensional grid. With respect to further possible designs of the plurality of microlenses 12 arranged in the form of a grid, reference is made here to the above statements.

The plurality of microimages 15 arranged in the form of a grid preferably consist in each case of one or more pixels, wherein in particular the shortest edge length or the smallest diameter of a pixel is smaller than 10 μm, preferably smaller than 5 μm, particularly preferably smaller than 2.5 μm.

Methods for producing a multilayer body, such as the multilayer body 1 shown in FIG. 1a, will be explained below with reference to FIGS. 1b to 1 d, wherein the generation of the plurality of microimages 15 arranged in the form of a grid is in particular also set out:

Thus, FIG. 1b to FIG. 1d schematically show methods for producing a multilayer body 1.

FIG. 1b shows a method for producing a multilayer body 1, in particular a multilayered security element for protecting security documents, wherein the method comprises the following steps, which are performed in particular in the following order:
a) providing a carrier layer 10;
b) applying a replication varnish layer 11a to the carrier layer 10;
c) molding a plurality of microlenses 12 arranged in the form of a grid into the replication varnish layer 11a;
d) applying a layer 14 to be structured to the side of the carrier layer 10 opposite the plurality of microlenses 12 arranged in the form of a grid;
e) structuring the one layer 14 to be structured using a separate high-resolution mask 23 such that a plurality of microimages 15 arranged in the form of a grid are formed by removal in areas of the one layer 14 to be structured.

It is advantageous if the one layer 14 to be structured applied in step d) and structured in step e) is a photoresist layer 16a, which in particular remains in the multilayer body 1 produced. Further preferably, the photoresist layer 16a is dyed, in particular dyed with dyes and/or pigments, contains fluorescent substances and/or is formed transparent.

Still further preferably, the photoresist layer 16a is first applied over the whole surface in particular in a layer thickness of between 0.5 μm and 1.5 μm.

It is further expedient if step e) further comprises at least one of the following steps:
exposing the photoresist layer 16a to light from the side of the carrier layer 10 opposite the plurality of microlenses 12 arranged in the form of a grid, preferably by means of an exposure light source, through the separate high-resolution mask, in particular in a step-and-repeat method;
aligning the separate high-resolution mask, in particular by means of register marks, which preferably make an angular misalignment and/or a distortion detectable, wherein the angular misalignment is further preferably smaller than 0.5°, preferably smaller than 0.3°, further preferably smaller than 0.1°, still further preferably smaller than 0.05°.

A contact-locking joining of the separate high-resolution mask with the photoresist layer 16a applied to the carrier layer 10, and in particular then an exposure of the photoresist layer 16a to light through the mask, is advantageously effected. The photoresist layer 16a is preferably thereby exposed to light in the areas of surface in which the mask is permeable to or transparent for the respective exposure radiation.

The photoresist layer 16a is then in particular developed and structured.

Thus, it is possible for in the plurality of microimages 15 arranged in the form of a grid shown in FIG. 1a to be formed of the photoresist layer 16a.

Furthermore, it is advantageous that a separate high-resolution mask with structures smaller than 10 μm, preferably smaller than 5 μm, further preferably smaller than 2.5 μm, is used in step e). With respect to the further possible design of the separate high-resolution mask, reference is made here to the above statements.

A positive photoresist, the solubility of which in particular increases when activated by exposure to light, or a negative photoresist, the solubility of which in particular decreases when activated by exposure to light, is preferably used to form the photoresist layer 16a.

In particular, a positive photoresist is characterized in that, when sufficiently exposed to light with a suitable wavelength, such as for example by means of UV radiation, this photoresist becomes soluble in a particular solvent, for example in acidic or basic aqueous solutions, in the exposed areas. In particular through an exposure to light using the separate high-resolution mask, dyed areas with defined shape and size, which preferably form the plurality of microimages 15 arranged in the form of a grid, can therefore preferably be achieved.

A positive photoresist preferably comprises for example condensation polymers of m- and p-cresol and formaldehyde (novolac resin), diazonaphthoquinone derivative (DNQ) and solvent or solvent mixture, such as for example 1-methoxy-2-propyl acetate.

Here, in particular, novolac resins are hydrophilic (OH groups) and soluble in aqueous base. In particular if the novolac resins are mixed with DNQ, the solubility of the novolac in a base is greatly reduced. In particular, an exposure of the inhibitor (DNQ) to light leads to the acid, which makes it possible for the exposed locations (A) of the photoresist to be able to be dissolved selectively by aqueous base (developer). In particular after the exposure to light, DNQ is converted to the indene carboxylic acid (ICA). The latter is in particular hydrophilic and ionizable.

In particular, a negative photoresist is characterized in that, when sufficiently exposed to light with a suitable wavelength, such as for example by means of UV radiation, this varnish cures, and thereby becomes insoluble in a particular solvent, for example in acidic or basic aqueous solutions, in the exposed areas. In particular through an exposure to light using the separate high-resolution mask, dyed areas with defined shape and size, which preferably form the plurality of microimages 15 arranged in the form of a grid, can therefore preferably be formed.

A negative photoresist is preferably based on epoxy resins and contains low-molecular-weight organic compounds, which have in particular more than one epoxide group per molecule. Epoxy resins based on bisphenol A, epoxidized phenol novolac, and/or resorcinol diglycidyl are further preferably used to generate negative photoresists.

In particular in conjunction with a crosslinker (curing agent), a so-called resin/curing agent system provides a macromolecular network through polymerization of the epoxide group. Here, in particular, different curing agents can be used, which are distinguished by the ring opening reaction of the oxirane groups. Acid anhydrides, amines or phenol-containing compounds are preferably used, or triarylsulfonium salts are used as photoactive component.

Furthermore, catalysts, such as e.g. Lewis bases and acids, are preferably used. The curing agent is preferably incorporated in the three-dimensional network structure. In particular, a catalyst promotes the network formation via ester bridges in the case of a basic accelerator. Preferably, g-butyrolactone is used in particular as solvent in the printing ink of such epoxy-resin-based photoresists. Additives, such as e.g. long-chain epoxy resins, are further preferably used in order to act on the one hand as adhesion promoter, reactive diluent or as an augmentation or lowering of the viscosity.

For example, the photoresist SU-8 epoxy novolac based on bisphenol A; triarylsulfonium hexafluoroantimonate; g-butyrolactone, MicroChem Corporation, Newton, USA, is used as negative photoresist.

For example, a negative photoresist further consists in particular of the following combination of solvent, binders and curing agent:
solvent: 1-methoxy-2-propanol proportion: 75%,
binder: urethane acrylate oligomer 15%,
binder: pentaerythritol tetraacrylate 2.5%,
binder: pentaerythritol triacrylate 1%,
binder: ethoxylated trimethylolpropane triacrylate 1%,
binder: acrylated oligomer 2.5%,
curing agent: Genocure ITX 3%.

FIG. 1c shows a method for producing a multilayer body 1, in particular a multilayered security element for protecting security documents, wherein the method comprises the following steps, which are performed in particular in the following order:
a) providing a carrier layer 10;
b) applying a replication varnish layer 11a to the carrier layer 10;
c) molding a plurality of microlenses 12 arranged in the form of a grid into the replication varnish layer 11a;
f) printing a control structure onto the side of the carrier layer 10 opposite the plurality of microlenses 12 arranged in the form of a grid by means of a first high-resolution digital printer;
g) detecting the control structure by means of a detection device from sides of the plurality of microlenses 12 arranged in the form of a grid such that the control structure is detected by means of the detection device through the plurality of microlenses 12 arranged in the form of a grid;
h) applying a printed layer in areas to the side of the carrier layer 10 opposite the plurality of microlenses 12 arranged in the form of a grid by means of a second high-resolution digital printer using the detected control structure such that a plurality of microimages 15 arranged in the form of a grid are formed by the printed layer.

The high-resolution digital printer used here, in particular the first and/or the second high-resolution digital printer, advantageously has a resolution of at least 6,000 dpi, preferably at least 12,000 dpi, further preferably of at least 24,000 dpi.

It further also makes sense if the detection device is an optical sensor, such as for example a CMOS and/or CCD sensor.

It is further preferred that an angular misalignment and/or a distortion is further detected in step g) with reference to the control structure.

Here, it is further preferred if, with reference to the detected angular misalignment and/or the detected distortion, the plurality of microimages 15 arranged in the form of a grid formed of the printed layer in step h) are applied registered relative to the plurality of microlenses 12 arranged in the form of a grid, wherein the angular misalignment is further preferably smaller than 0.5°, preferably smaller than 0.3°, further preferably smaller than 0.1°, still further preferably smaller than 0.05°.

It is also possible if the method further comprises the following step, which is carried out in particular between steps g) and h):
compensating for the angular misalignment and/or the distortion such that the plurality of microimages 15 arranged in the form of a grid formed of the printed layer in step h) are applied registered relative to the plurality of microlenses 12 arranged in the form of a grid.

Furthermore, it is expedient that after step h) a metal layer and/or a layer made of a transparent dielectric and/or at least one colored varnish layer is applied to the printed layer.

FIG. 1d shows a method for producing a multilayer body 1, in particular a multilayered security element for protecting security documents, wherein the method comprises the following steps, which are performed in particular in the following order:
a) providing a carrier layer 10;
b) applying a first replication varnish layer 11a to the carrier layer 10;
c) molding a plurality of microlenses 12 arranged in the form of a grid into the first replication varnish layer 11a;
i) applying a second replication varnish layer to the side of the carrier layer 10 opposite the plurality of microlenses 12 arranged in the form of a grid;
j) molding a subwavelength plasmonic structure in areas into the second replication varnish layer such that a plurality of microimages 15 arranged in the form of a grid are formed by the molded subwavelength plasmonic structure;
k) applying a metal layer to the second replication varnish layer.

In step k) the metal layer is advantageously applied such that plasmonic colors are generated by an interaction of the subwavelength plasmonic structure molded into the second replication varnish layer and the metal layer.

The subwavelength plasmonic structure preferably comprises grating structures selected from the group two-dimensional gratings, cross gratings, hexagonal gratings. Such grating structures further preferably have a grating period of between 150 nm and 400 nm and further preferably between 200 nm and 350 nm, and a relief depth of between 50 nm and 400 nm and further preferably between 150 nm and 350 nm.

It is further conceivable that before step i) at least one color filter layer is applied to the carrier layer 10 in particular over the whole surface, preferably applied to the side of the carrier layer 10 opposite the plurality of microlenses 12 arranged in the form of a grid.

FIG. 2 schematically shows a method for generating a separate high-resolution mask 23.

As shown in FIG. 2, a glass substrate 23a coated with a chromium layer 23b, in particular made of high-purity quartz glass or calcium fluoride, is provided, wherein a photoresist layer 16d is further applied to the chromium layer 23b. In a first step the photoresist layer 16d is exposed to light by means of a laser or an electron beam to structure the chromium layer 23b on the glass substrate 23a. In a further step the photoresist layer 16d is developed, wherein, in particular when a positive photoresist is used, the exposed areas are removed. The chromium layer 23b is then etched, wherein the areas covered by the photoresist layer 16d, as shown in FIG. 2, are protected from the etchant and are thus not removed. In the subsequent step the photoresist 16d is in particular completely removed. In the last step a so-called pellicle, by which is meant in particular a thin, transparent membrane which covers the separate high-resolution mask, is applied.

The separate high-resolution mask 23 is advantageously generated by means of electron-beam lithography methods. However, it is also possible for the separate high-resolution mask 23 to be generated by means of laser-beam lithography methods, wherein here lower resolutions are typically achieved than in the case of electron-beam lithography methods. With these methods, structures smaller than 10 μm, preferably smaller than 5 μm, further preferably smaller than 2.5 μm, are preferably generated.

The thus-generated separate high-resolution mask 23 thus preferably comprises the following layers: a glass substrate 23a, in particular made of high-purity quartz glass or calcium fluoride, a chromium layer 23b, in particular an optically dense chromium layer, optionally an adhesion-promoter layer and optionally a pellicle 23c.

FIG. 3a to FIG. 3c schematically show sectional representations of multilayer bodies.

Thus, a multilayer body 1 is shown in FIG. 3a comprising a replication varnish layer 11a with a plurality of microlenses 12 arranged in the form of a grid molded therein, an adhesion-promoter layer 13, a carrier layer 10, a photoresist layer 16a, which is shaped such that it forms a plurality of microimages 15 arranged in the form of a grid, and a primer layer.

With respect to the design of the layers 10, 11a, 12, 13, 15 and 16a, reference is made here to the above statements.

As shown in FIG. 3a, the primer layer 24 is applied to the side of the plurality of microimages 15 arranged in the form of a grid facing away from the carrier layer 10. The primer layer 24 is preferably a thermally activatable layer, which further preferably has a layer thickness of between 0.3 μm and 25 μm and is preferably deposited over the whole surface. The primer layer 24 can in particular be constructed monolayered or multilayered. Furthermore, the primer layer 24 can in particular be constructed on an aqueous, solvent-containing or radiation-curing basis and/or combinations thereof. The following can in particular be used as binder for the primer layer 24: polyacrylates, polyurethanes, epoxides, polyesters, polyvinyl chlorides, rubber polymers, ethylene acrylic acid copolymers, ethylene vinyl acetates, polyvinyl acetates, styrene block copolymers, phenol formaldehyde resin adhesives, melamines, alkenes, allyl ether, vinyl acetate, alkyl vinyl ether, conjugated dienes, styrene, acrylates and the mixtures of the above raw materials and their copolymers. In particular, water, aliphatic (benzine) hydrocarbons, cycloaliphatic hydrocarbons, terpene hydrocarbons, aromatic (benzene) hydrocarbons, chlorinated hydrocarbons, esters, ketones, alcohols, glycols, glycol ethers, glycol ether acetates can be used as solvent.

Furthermore, in particular, curing agents, crosslinkers, photoinitiators, fillers, stabilizers, inhibitors, additives such as e.g. flow additives, defoamers, deaerators, dispersing additives, wetting agents, lubricants, matting agents, rheology additives, pigments and dyes or waxes can be added to the primer layer 24.

The primer layer 24 is preferably applied by means of a printing method such as e.g. gravure printing, screen printing, flexographic printing, inkjet printing, pouring or by means of a doctor-blade method. With respect to the further production of such a multilayer body 1, reference is made here to the above statements.

The primer layer 24 shown in FIG. 3a is for example a thermally activatable layer made of binder and optionally further auxiliary agents, which further has a layer thickness of from 0.3 μm to 25 μm.

The multilayer body 1 shown in FIG. 3b corresponds to the multilayer body shown in FIG. 3a with the difference that it further comprises the edge emitter layer 21. As shown in FIG. 3b, the edge emitter layer 21 is arranged on the side of the plurality of microlenses 12 arranged in the form of a grid facing the plurality of microlenses 12 arranged in the form of a grid, in particular on the side facing an observer. It is also possible for the edge emitter layer 21 to cover the whole plurality of microlenses 21 arranged in the form of a grid, in particular wherein the layer thickness of the edge emitter layer 21 is smaller, in particular much smaller, than the lens height. Here, it is further possible for more material of the edge emitter layer 21 to accumulate in the intermediate spaces between the microlenses 12.

The edge emitter layer 21 shown in FIG. 3b is for example a layer made of a binder with auxiliary agents, for example additives, wherein the edge emitter layer 21 further contains fluorescent substances. With respect to the binders and the fluorescent substances and further possible designs of the edge emitter layer 21, reference is made here to the above statements.

The multilayer body 1 shown in FIG. 3c corresponds to the multilayer body 1 shown in FIG. 3b with the difference that the edge emitter layer 21 is arranged on the side of the carrier layer opposite the plurality of microlenses arranged in the form of a grid. Thus, the edge emitter layer 21 in the multilayer body 1 shown in FIG. 3c is arranged between the carrier layer 10 and the primer layer 24.

It is further possible for the total thickness of the multilayer body 1 to be smaller than 50 μm, preferably to be smaller than 35 μm, still further preferably smaller than 25 μm.

FIG. 4a and FIG. 4b show a method for producing a multilayer body 1, and a multilayer body 1.

The multilayer body shown in FIG. 4a and FIG. 4b is preferably produced with the method explained with reference to FIG. 1b with the difference that the layer 14 to be structured applied in step d) and structured in step e) comprises a colored varnish layer 17a, which is applied to the photoresist layer 16a in particular over the whole surface. The colored varnish layer 17a is then structured registration-accurately with the photoresist layer 16a in step e).

The colored varnish layer 17a shown in FIG. 4a and FIG. 4b is a layer which, unlike the photoresist layer 16a, is itself not able to be exposed to light or structured. As shown in FIG. 4a, the colored varnish layer 17a is structured in the same step in which the photoresist layer 16a is structured. In other words, the colored varnish layer 17a is removed together with the photoresist layer 16a. With respect to the further possible design of the colored varnish layer 17a, reference is made here to the above statements.

Thus, the following method steps are shown in particular in FIG. 4a: —structuring and removing the photoresist layer 16a, wherein the colored varnish layer 17a arranged underneath, in particular when the multilayer body 1 is viewed from sides of the plurality of the microlenses 12 arranged in the form of a grid, is removed registration-accurately together with the photoresist 16a.

The removal of photoresist layers, such as here the photoresist layer 16a, is generally also referred to as so-called stripping.

As shown in FIG. 4b, the multilayer body is then also vapor-coated with a metal layer 18c, in particular to increase the contrast, with the result that a multilayer body 1 is obtained which comprises the following layers:

a replication varnish layer 11a with a plurality of microlenses 12 arranged in the form of a grid molded therein, an adhesion-promoter layer 13, a carrier layer 10, a structured layer 14 comprising a photoresist layer 16a and a colored varnish layer 17a, wherein the structured layer 14 is shaped such that it forms a plurality of microimages 15 arranged in the form of a grid, and a metal layer 18c.

The metal layer 18c is expediently a layer made of aluminum, silver, chromium, copper, tin, indium, gold, zinc or an alloy of the above-named metals. It is further also possible for the metal layer 18c to be a layer made of aluminum or silver blackened by oxidation, such as for example substoichiometric AlₓO_{y}. It is further useful if the layer thickness of the of the metal layer lies between 1 nm and 500 nm, preferably between 5 nm and 100 nm.

The metal layer 18c shown in FIG. 4b is for example a metal layer made of aluminum with a layer thickness of 20 nm. With respect to further possible designs of the metal layer, reference is made here to the above statements.

FIG. 5 schematically shows a sectional representation of a multilayer body 1.

The multilayer body 1 shown in FIG. 5 comprises a replication varnish layer 11a with a plurality of microlenses 12 arranged in the form of a grid molded therein, an adhesion-promoter layer 13, a carrier layer 10, a photoresist layer 16a, which is shaped such that it forms a plurality of microimages 15 arranged in the form of a grid, a colored varnish layer 17d and a metal layer 18c.

With respect to the design of the layers 10, 11a, 12, 13, 16a and 18c, reference is made here to the above statements.

The multilayer body 1 shown in FIG. 5 is preferably produced with the method explained with reference to FIG. 1b with the difference that the colored varnish layer 17d is preferably applied in particular over the whole surface after step e).

The photoresist layer 16a is preferably dyed, in particular dyed with dyes and/or pigments. The dyes preferably generate a color from the RGB color space (R=red; G=green; B=blue) or the CMYK color space (C=cyan; M=magenta; Y=yellow; K=black). However, it is also possible for the dyes to generate a color from a special color space, such as for example the RAL, HKS or Pantone® color space. The dyes further preferably generate a color from the CIELAB color space.

Thus, it is possible for example for the photoresist layer 16a to be dyed with Orasol dyes and/or Microlith color pigments and/or Luconyl.

It is further possible for the photoresist layer 16a to be transparent, in particular for the photoresist layer 16a to have a transmittance for visible light, preferably from the wavelength range between 380 nm and 780 nm, of more than 50%, preferably more than 70%, further preferably of more than 85%, still further preferably of more than 90%.

The photoresist layer shown in FIG. 5 is for example a dyed photoresist layer which has a transmittance of more than 50%. With respect to further possible designs of the photoresist layer 16a, reference is made here to the above statements.

The colored varnish layer 17d preferably generates a color from the RGB color space (R=red; G=green; B=blue) or the CMYK color space (C=cyan; M=magenta; Y=yellow; K=black). However, it is also possible for the colored varnish layer 17d to generate a color from a special color space, such as for example the RAL, HKS or Pantone® color space. The colored varnish layer 17d further preferably generates a color from the CIELAB color space.

It is advantageous if the layer thickness of the color layer is between 0.1 μm and 10 μm, preferably between 0.1 μm and 5 μm. Thus, the colored varnish layer 17d shown in FIG. 5 has for example a layer thickness of 2.5 μm. With respect to possible designs of the colored varnish layer 17d, reference is made here to the above statements.

The colored varnish layer 17d is advantageously applied by printing, in particular by means of offset printing and/or gravure printing and/or flexographic printing and/or inkjet printing.

In particular in order to achieve a sufficient contrast, the colors of the corresponding layers, here the photoresist layer 16a and the colored varnish layer 17d, are preferably chosen as follows:

The photoresist layer 16a, which faces the replication varnish layer 11a, preferably has a darker color, in particular with a low lightness value L, and the colored varnish layer 17d, which, when viewed from the side of the plurality of microlenses 12 arranged in the form of a grid, is arranged behind, has the lighter color, in particular with a higher lightness value L.

It is further preferred if the photoresist layer 16a and the colored varnish layer 17d have in each case a total ink holdout dE from each other in the CIELAB color space of from 50 to 270, preferably from 100 to 270, further preferably from 130 to 270.

In particular, a particularly good contrast is achieved hereby, which is preferably determined in the CIELAB color space by the total ink holdout dE. According to the CIELAB system, as represented schematically in FIG. 6, the color space is in particular represented by a sphere K, wherein this is defined by the three axes lightness L, red-green axis a and yellow-blue axis b. In particular, here, L=100 corresponds to white, L=0 corresponds to black and L=50 corresponds to the achromatic point. The total color distance dE is further determined as follows:

dE=((dL)²+(da)²+(db)²)^{1/2},

wherein in particular dL is the lightness difference, da is the color difference on the red-green axis and db is the color difference on the yellow-blue axis between two colors.

If the value ranges lie for example between −100 and 150 for the red-green axis a and yellow-blue axis b and between 0 and 100 for the lightness axis L, with the result that a, b∈(−100; 150) and L∈(0; 100), then the following results for example for a very light yellow (100L, 0a, 150b) and a very dark blue (0L, 0a, −100b) as total color distance between the two colors: dE=((100−0)²+(0−0)²+(150−(−100))²)^{1/2}=((100)²+(0)²+(250)²)^{1/2}=269.26. For example in the case of a dark photoresist layer 16a (30L, 0a, −70b) and a light colored varnish layer 17d (80L, 0a, 70b), the following further results as total color distance dE=((80−30)²+(0−0)²+(70+70)²)^{1/2}=148. As a still further example, in the case of a dark photoresist layer 16a (40L, 0a, −50b) and a light colored varnish layer 17d (50L, 0a, 50b), the following results as total color distance dE=((50−40)²+(0−0)²+(100)²)^{1/2}=100.5.

FIG. 7 to FIG. 10 schematically show sectional representations of multilayer bodies 1.

A multilayer body 1 with a carrier layer 10 and a replication varnish layer 11a, applied to the carrier layer 10, into which a plurality of microlenses 12 arranged in the form of a grid are molded, is shown in FIG. 7. The multilayer body shown in FIG. 7 further also comprises the photoresist layers 16a and 16b as well as the metal layer 18c. With respect to the design of the layers 10, 11a, 12, 13 and 18c, reference is made here to the above statements.

The photoresist layer 16a here comprises UV-blocking additives, which in particular absorb light from the ultraviolet wavelength range, preferably from the wavelength range between 200 nm and 380 nm. Such UV-blocking additives further preferably have no or only a very low absorption in the wavelength range visible to the human eye from 380 nm to 780 nm.

The UV-blocking additives are advantageously for example benzotriazole derivatives, which are used in the corresponding layers in particular with a proportion by mass in a range of from approx. 3% to 5%. Suitable organic UV absorbers are sold for example under the trade name Tinuvin® by BASF, Ludwigshafen, Germany.

In addition to the photoresist layer 16a, the multilayer body 1 shown in FIG. 7 also comprises the photoresist layer 16b, wherein the photoresist layer 16b has an exposure principle that complements the photoresist layer 16a and/or wherein the solubility of the photoresist layer 16b is alterable at a different exposure wavelength than in the case of the photoresist layer 16a, and wherein the photoresist layer 16b is further arranged register-accurately next to the photoresist layer 16a.

Such a multilayer body 1 is preferably produced with the method explained with reference to FIG. 1b with the difference that the method further comprises the following steps, which are carried out in particular after step e):
applying the photoresist layer 16b to the photoresist layer 16a, in particular wherein the photoresist layer 16b has an exposure principle that complements the photoresist layer 16a and/or wherein the solubility of the photoresist layer 16b is altered at a different exposure wavelength than in the case of the photoresist layer 16a;
exposing the photoresist layer 16b to light from the side of the carrier layer 10 having the plurality of microlenses 12 arranged in the form of a grid, in particular by means of an exposure light source;
structuring the photoresist layer 16b, in particular such that the photoresist layer 16b is arranged register-accurately next to the photoresist layer 16a.

By a complementary exposure principle is meant here in particular the use of an exposure principle that counteracts the exposure principle of the photoresist layer 16a. Thus, it is by a complementary exposure principle is preferably meant that a positive photoresist, the solubility of which in particular increases when activated by exposure to light, is used to form the photoresist layer 16a and a negative photoresist, the solubility of which in particular decreases when activated by exposure to light, is used to form the photoresist layer 16b, or vice versa.

In other words, the photoresist layer 16a applied first, as described with reference to FIG. 1b, is first developed and structured by means of the separate high-resolution mask. The photoresist layer 16b is then applied, which has an exposure principle that complements the photoresist layer 16a, as set out above. The photoresist layer 16b is then exposed to light from the side of the microlenses 12 through the microlenses 12, wherein the photoresist layer 16a acts as a mask for the structuring of the photoresist layer 16b because of the UV-blocking additives. Finally, the photoresist layer 16b is developed and structured.

The photoresist layers 16a and 16b are preferably dyed differently, with the result that a multilayer body 1 is generated, in which the photoresist layer 16b is arranged in exact register next to the photoresist layer 16b, with the result that for example colored microimages with very high resolution are generated, which are surrounded by a differently colored background. With respect to further possibilities for dyeing the photoresist layers 16a and 16b, reference is made here to the above statements.

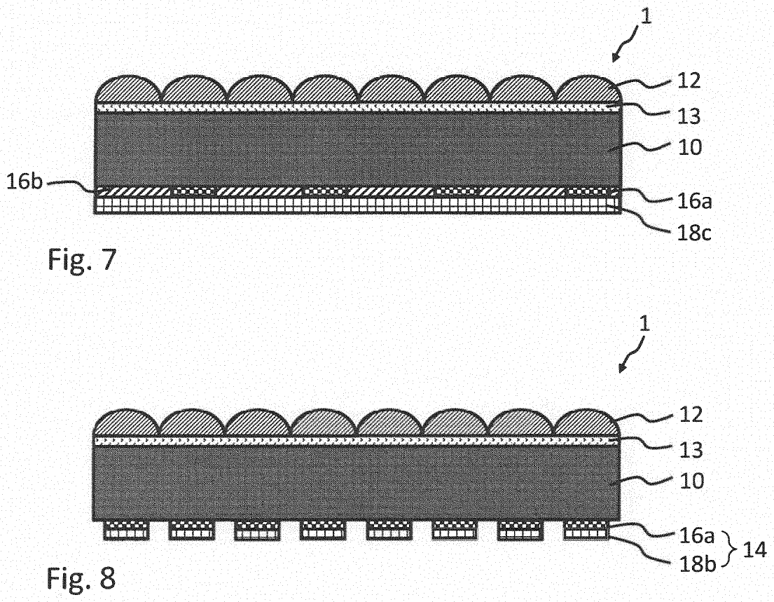

FIG. 8 shows a multilayer body 1 with a carrier layer 10 and a replication varnish layer 11a, applied to the carrier layer 10, into which a plurality of microlenses 12 arranged in the form of a grid are molded. The multilayer body shown in FIG. 8 further also comprises the photoresist layer 16a and the metal layer 18b.

As shown in FIG. 8, the metal layer 18b is applied to the photoresist layer 16a on the side of the photoresist layer 16a facing away from the plurality of microlenses 12 in the form of a grid and is further also arranged registration-accurately with the photoresist layer 16a.

As already explained in connection with FIG. 7, the photoresist layer 16a here also comprises UV-blocking additives here, which in particular absorb light from the ultraviolet wavelength range, preferably from the wavelength range between 200 nm and 380 nm. In this respect, reference is also made here to the above statements.

With respect to the design of the layers 10, 11a, 12, 13, 16a and 18b, reference is also made here to the above statements.

Such a multilayer body 1 is preferably produced with the method explained with reference to FIG. 1b with the difference that the method further comprises the following steps, which are carried out in particular after step e):
applying the metal layer 18b to the photoresist layer 16a; —applying a further photoresist layer to the metal layer 18b;
exposing the further photoresist layer to light from the side of the carrier layer 10 having the plurality of microlenses 12 arranged in the form of a grid, in particular by means of an exposure light source;
structuring the further photoresist layer and the metal layer 18b, in particular with the result that the metal layer 18b is arranged registration-accurately with the photoresist layer 16a and the further photoresist layer. The further photoresist layer is then preferably removed again.

The exposure light source is preferably for example a UV lamp or UV LED.

The layer thickness of the photoresist layer 16a and of the further photoresist layer is advantageously less than 15 μm, preferably less than 5 μm.

In other words, the photoresist layer 16a, as described with reference to FIG. 1b, here is also first developed and structured by means of the separate high-resolution mask. Then the metal layer 18b is applied, for example vapor-deposited. In a further step, metal layer 18b is coated with the further photoresist layer in particular over the whole surface. The further photoresist layer is then exposed to light from the side of the microlenses 12 through the microlenses 12, wherein the photoresist layer 16a acts as a mask for the structuring of the further photoresist layer because of the UV-blocking additives. Finally, the further photoresist layer is developed and structured together with the metal layer 18b lying underneath.

The metal layer 18b here is preferably formed transparent or at least partially transparent, with the result that in particular the light emitted by the exposure light source passes through the metal layer 18b to the further photoresist layer. For this purpose, the metal layer 18b preferably has a layer thickness of less than 15 nm.

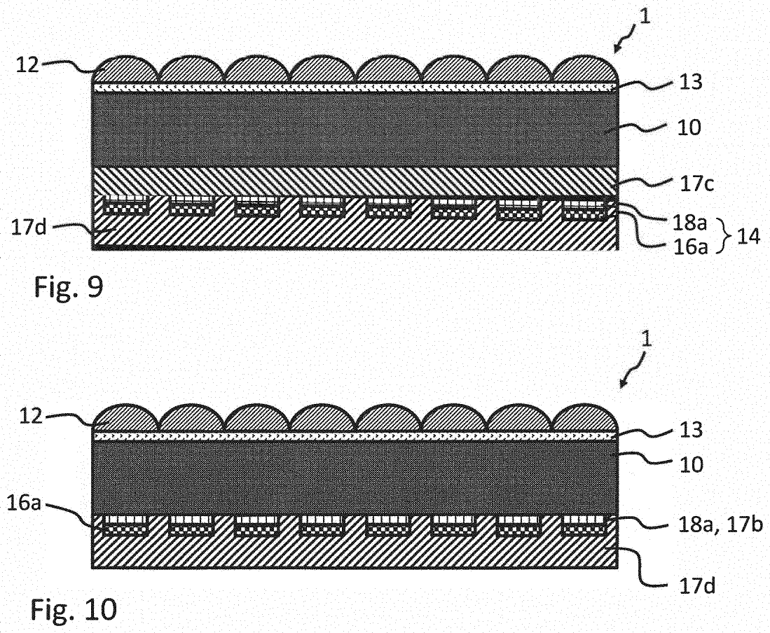

FIG. 9 shows a multilayer body 1 with a carrier layer 10 and a replication varnish layer 11a, applied to the carrier layer 10, into which a plurality of microlenses 12 arranged in the form of a grid are molded. The multilayer body shown in FIG. 9 further also comprises the colored varnish layers 17c and 17d, the photoresist layer 16a and the metal layer 18a.

As shown in FIG. 9, the metal layer 18a, which is arranged on the photoresist layer 16a on the side facing the plurality of microlenses 12 in the form of a grid, is further also arranged registration-accurately with the photoresist layer 16a.

The colored varnish layers 17c and 17d, as shown in FIG. 9, however, are applied over the whole surface, wherein the colored varnish layer 17c, when viewed from the side of the plurality of microlenses 12 arranged in the form of a grid, is arranged in front of the structured metal layer 18a and the photoresist layer 16a and the colored varnish layer 17d is arranged behind the structured metal layer 18a and the photoresist layer 16a. The metal layer 18a and the photoresist layer 16a therefore form the structured layer 14 here.

It also makes sense here to choose the color values of the colored varnish layers 17c and 17d as well as the color value of the photoresist layer 16a and of the metal layer 18a according to the above-explained details, with the result that reference is made in this respect to the above statements.

Thus, it is advantageous if the colored varnish layer 17c and/or the colored varnish layer 17d has a total ink holdout dE from the structured layer 14, preferably in the CIELAB color space, of from 50 to 270, preferably from 100 to 270, further preferably from 130 to 270, in particular wherein the structured layer 14, as shown in FIG. 9, comprises the photoresist layer 16a and the metal layer 18a.

Furthermore, it is alternatively or additionally advantageous if, of the colored varnish layers 17c and/or 17d and the structured layer 14, which in particular comprises the photoresist layer 16a and the metal layer 18a, the layer that faces the microlenses 12 has a darker color, in particular with a low lightness value L, and the layer that, when viewed from the side of the plurality of microlenses 12 arranged in the form of a grid, is arranged behind has the lighter color, in particular with a higher lightness value L.

With respect to the design of the layers 10, 11a, 12, 13, 16a, 17a, 17d and 18a, reference is also made here to the above statements.

Such a multilayer body 1 is preferably produced with the method explained with reference to FIG. 1b with the difference that the colored varnish layer 17c is first applied over the whole surface before step d). The layer 14 applied in step d) and structured in step e) here also further comprises the metal layer 18a, which is first applied over the whole surface before the application of the photoresist layer 16a to the side of the carrier layer 10 opposite the plurality of microlenses 12 arranged in the form of a grid. Here too, it is advantageous if the metal layer 18a is then structured registration-accurately with the at least one first photoresist layer in step e). It is also possible for the photoresist layer 16a to be removed again in particular after step e). The photoresist layer 17d, as shown in FIG. 9, is then applied over the whole surface.

In other words, here, as described in particular in principle with reference to FIG. 1b, in addition to the photoresist layer 16a the metal layer 18a previously vapor-deposited first over the whole surface for example is structured together with the photoresist layer 16a using the separate high-resolution mask. The colored varnish layers 17c and 17d were further additionally applied beforehand or afterwards, in order to generate mixed colors or a colored background.

Here too, it is advantageous if the colored varnish layer 17c, in particular applied before step d), and/or the colored varnish layer 17d, in particular applied after step e), has a total ink holdout dE from the structured layer 14, which in particular, as shown in FIG. 9, comprises the metal layer 18a and the photoresist layer 16a, preferably in the CIELAB color space, of from 50 to 270, preferably from 100 to 270, further preferably from 130 to 270.

It is alternatively or additionally advantageous if, of the colored varnish layer 17c, in particular applied before step d), and/or of the colored varnish layer 17d, in particular applied after step e), and the structured layer 14, which in particular, as shown in FIG. 9, comprises the metal layer 18a and the photoresist layer 16a, the layer that faces the microlenses 12 has a darker color, in particular with a low lightness value L, and the layer that, when viewed from the side of the plurality of microlenses 12 arranged in the form of a grid, is arranged behind has the lighter color, in particular with a higher lightness value L.

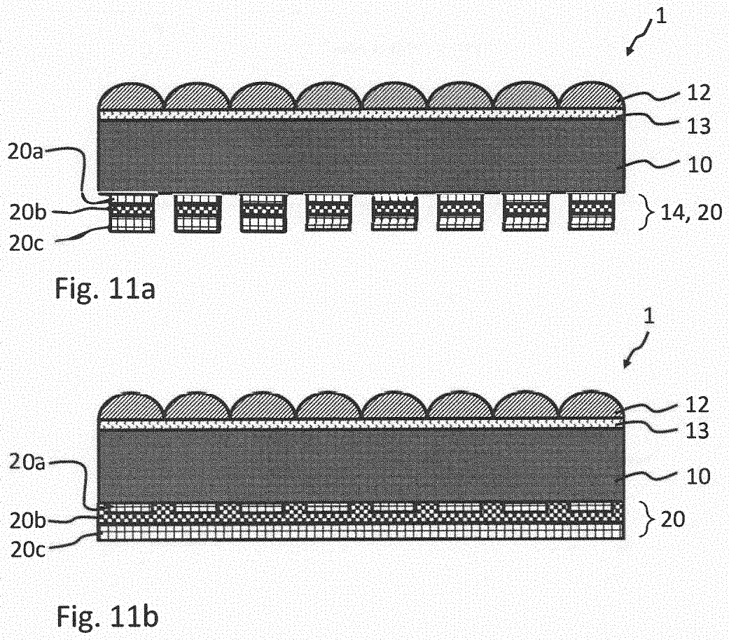

The multilayer body 1 shown in FIG. 10 corresponds to the multilayer body shown in FIG. 9 with the difference that the whole-surface colored varnish layer 17c is not present. The multilayer body 1 shown in FIG. 10 is produced analogously to the multilayer body shown in FIG. 9. It is also possible for example to replace and/or supplement the metal layer 18a with a colored varnish layer 17b. Such a multilayer body is also produced analogously to the multilayer body shown in FIG. 9, with the result that reference is made in this respect to the above statements.

FIG. 11a to FIG. 11c schematically show sectional representations of multilayer bodies 1.

FIG. 11a shows a multilayer body 1 with a carrier layer 10 and a replication varnish layer 11a, applied to the carrier layer 10, into which a plurality of microlenses 12 arranged in the form of a grid are molded. The multilayer body shown in FIG. 11a further also comprises the thin film layer system 20, which comprises the partially transparent metal layer 20a, the dielectric spacing layer 20b and the opaque metal layer 20c, and is formed of the structured layer 14. The thin film layer system 20 further forms the plurality of microimages 15 arranged in the form of a grid.

The partially transparent metal layer 20a here preferably has an optical density OD of approximately 0.6 and the opaque metal layer has an optical density OD of approximately 1.9. For example, the metal layers 20a and 20c here are formed of aluminum.

With respect to the design of the layers 10, 11a, 12 and 13, reference is also made here to the above statements.

Such a multilayer body 1 is preferably produced with the method explained with reference to FIG. 1b with the difference that the layer 14 applied in step d) and structured in step e) here further contains the thin film layer system 20, which comprises the partially transparent metal layer 20a, the dielectric spacing layer 20b and the opaque metal layer 20c. Before the application of the photoresist layer 16a to the side of the carrier layer 10 opposite the plurality of microlenses 12 arranged in the form of a grid, the thin film layer system 20 is first applied over the whole surface, in particular by means of sputtering, physical vapor deposition (PVD), chemical vapor deposition (CVD) or gravure printing. The thin film layer system 20 is then structured registration-accurately with the photoresist layer 16a in step e) and the photoresist layer 16a is in particular removed again after step e).

In other words, here, as described in particular in principle with reference to FIG. 1b, in addition to the photoresist layer 16a, the thin film layer system previously brought over the whole surface first is structured together with the photoresist layer 16a using the separate high-resolution mask.

The multilayer body 1 shown in FIG. 11b corresponds to the multilayer body shown in FIG. 11a with the difference that the layers 20b and 20c of the thin film layer system 20, unlike the multilayer body shown in FIG. 11a, are formed over the whole surface. The plurality of microimages 15 arranged in the form of a grid or the shape and/or contour thereof are formed here in particular by the structured partially transparent metal layer 20a.

The multilayer body shown in FIG. 11b is produced like the multilayer body shown in FIG. 11a with the difference that the layer 14 applied in step d) and structured in step e) here has only the partially transparent metal layer 20a. The further layers 20b and 20c of the thin film layer system 20 are then applied over the whole surface. Here, it is further possible for the dielectric spacing layer 20b further to function as a replication layer, into which microstructures with a relief depth of less than 200 nm are preferably molded.

The multilayer body shown in 11c corresponds to the multilayer body shown in FIG. 11a with the difference that the layers 20a and 20b of the thin film layer system 20, unlike the multilayer body shown in FIG. 11a, are formed over the whole surface. The multilayer body 1 shown in FIG. 11c further also comprises the colored varnish layer 17d applied over the whole surface. The plurality of microimages 15 arranged in the form of a grid or the shape and/or contour thereof are formed here in particular by the structured opaque metal layer 20c. With respect to the design of the layers 10, 11a, 12, 13, 17d, 20a, 20b and 20c, reference is made here to the above statements.

The multilayer body shown in FIG. 11c is produced like the multilayer body shown in FIG. 11a with the difference that the layers 20a and 20b are first applied over the whole surface. Further, there is the difference that the layer 14 applied in step d) and structured in step e) here has only the opaque metal layer 20c. The colored varnish layer 17d is then further applied over the whole surface.

FIG. 12a and FIG. 12b schematically show sectional representations of multilayer bodies 1.

The multilayer body 1 shown in FIG. 12a corresponds for example to the multilayer body 1 shown in FIG. 3a with the difference that the plurality of microlenses 12 arranged in the form of a grid are only applied in areas. As shown in FIG. 12a, the plurality of microlenses 12 arranged in the form of a grid are present here only in the area 25b. The same applies the to the plurality of microimages 15 arranged in the form of a grid, with the result that the optically variable effect generated by the interaction of the microlenses 12 and the microimages 15 is only generated in the area 25b. The multilayer body 1 shown in FIG. 12a further also comprises the replication varnish layer 11c, which is applied over the whole surface and is arranged on the side of the plurality of microimages 15 arranged in the form of a grid facing away from the carrier layer 10. A relief structure 22 is further stamped into the replication varnish layer 11c in areas. The metal layer 18c is further also applied to the replication varnish layer 11c at least in the area 25a.

The relief structure 22 here is preferably a diffractive grating, a Kinegram® or hologram, a blazed grating, a binary grating, a multi-step phase grating, a linear grating, a cross grating, a hexagonal grating, an asymmetrical or symmetrical grating structure, a retroreflective structure, in particular a binary or continuous free-form surface, a diffractive or refractive macrostructure, in particular a lens structure or microprism structure, a microlens, a microprism, a zero-order diffraction structure, a moth-eye structure or anisotropic or isotropic matte structure, or a superimposition or combinations of two or more of the above-named relief structures. Thus, the relief structure shown in FIG. 12a is for example a Kinegram®.

With respect to the design of the layers 10, 11a, 12, 13, 15, 11c, 18c and 24, reference is made here to the above statements.

The multilayer body 1 shown in FIG. 12b corresponds to the multilayer body 1 shown in FIG. 12a with the difference that the plurality of microlenses 12 arranged in the form of a grid and the plurality of microimages 15 arranged in the form of a grid are applied over the whole surface. The multilayer body shown in FIG. 12b, unlike the multilayer body shown in FIG. 12a, further comprises no primer layer 24.

As shown in FIG. 12b, the plurality of microimages 15 and microlenses 12 arranged in the form of a grid completely overlap with the relief structure 22 stamped into the replication varnish layer 11c.

### LIST OF REFERENCE NUMBERS

1 multilayer body
10 carrier layer
11a, 11c replication varnish layers
12 microlenses
13 adhesion-promoter layer
14 structured layer, layer to be structured
15 microimages
16a, 16b, 16d photoresist layers
17a, 17b, 17c, 17d colored varnish layers
18a, 18b, 18c, 20c metal layers
20 thin film layer system
20a partially transparent metal layer
20b dielectric spacing layer
21 edge emitter layer
22 relief structure
23 separate high-resolution mask
23a glass substrate
23b chromium layer
23c pellicle
24 primer layer
25a, 25b areas

1. A method for producing a multilayer body, wherein the method comprises the following steps:
a) providing a carrier layer;
b) applying a first replication varnish layers to the carrier layer;
c) molding a plurality of microlenses arranged in the form of a grid into the first replication varnish layer;
d) applying at least one layer to be structured to the side of the carrier layer opposite the plurality of microlenses arranged in the form of a grid;
e) structuring the at least one layer to be structured using a separate high-resolution mask such that a plurality of microimages arranged in the form of a grid are formed by removal in areas of the at least one layer to be structured.

2. The method according to claim 1, wherein
the at least one layer to be structured applied in step d) and structured in step e) comprises or is a first photoresist layer.

3. The method according to claim 2, wherein
a positive photoresist, or a negative photoresist, is used to form the at least one first photoresist layer.

4. The method according to claim 2, wherein
the at least one layer to be structured applied in step d) and structured in step e) comprises at least one first colored varnish layer, which is applied to the at least one first photoresist layer.

5. The method according to claim 4, wherein
the at least one first colored varnish layer is structured in step e) registration-accurately with the at least one first photoresist layer.

6. The method according to claim 2, wherein
the at least one layer to be structured applied in step d) and structured in step e) comprises or is at least one second colored varnish layer and/or at least one first metal layer and/or at least one layer made of a transparent dielectric and/or at least one thin film layer system.

7. The method according to claim 6, wherein
the at least one second colored varnish layer and/or the at least one first metal layer and/or the at least one layer made of a transparent dielectric and/or the at least one thin film layer system is structured in step e) registration-accurately with the at least one first photoresist layer.

8. The method according to claim 2, wherein
the at least one first photoresist layer is removed.

9. The method according to claim 2, wherein
the at least one first photoresist layer applied in step d) and structured in step e) further contains UV-blocking additives.

10. The method according to claim 9, wherein
the method further comprises the following steps:
applying at least one second photoresist layer to the at least one first photoresist layer;
exposing the at least one second photoresist layer to light from the side of the carrier layer having the plurality of microlenses arranged in the form of a grid;
structuring the at least one second photoresist layer.

11. The method according to claim 10, wherein
a positive photoresist is used to form the at least one first photoresist layer and a negative photoresist is used to form the at least one second photoresist layer, or vice versa.

12. The method according to claim 9, wherein
the method further comprises the following steps:
applying at least one second metal layer to the at least one first photoresist layer;
applying at least one third photoresist layer to the at least one second metal layer;
exposing the at least one third photoresist layer to light from the side of the carrier layer having the plurality of microlenses arranged in the form of a grid;
structuring the at least one third photoresist layer and the at least one second metal layer.

13. The method according to claim 2, wherein
the at least one first photoresist layer is developed.

14. The method according to claim 1, wherein
at least one third colored varnish layer and/or at least one partially transparent metal layer and/or at least one dielectric spacing layer is applied to the carrier layer before step d).

15. The method according to claim 1, wherein
after step e) at least one fourth colored varnish layer and/or at least one third metal layer and/or at least one further replication varnish layer is applied to the at least one layer to be structured.

16-17. (canceled)

18. The method according to claim 1, wherein
the layers selected from the group: at least one first photoresist layer, at least one second photoresist layer, at least one first colored varnish layer, at least one second colored varnish layer, at least one third colored varnish layer, at least one fourth colored varnish layer, at least one first metal layer, dyed carrier layer have in each case a total ink holdout dE from each other in the CIELAB color space of from 50 to 270.

19. The method according to claim 1, wherein
of the layers selected from the group: at least one first photoresist layer, at least one second photoresist layer, at least one first colored varnish layer, at least one second colored varnish layer, at least one third colored varnish layer, at least one fourth colored varnish layer, at least one first metal layer, dyed carrier layer, the layer that faces the first replication varnish layer has a darker color, and the layer that, when viewed from the side of the plurality of microlenses arranged in the form of a grid, is arranged behind has the lighter color.

20. The method according to claim 1, wherein
the at least one layer to be structured applied in step d) and structured in step e) comprises at least two layers selected from the group: at least one first photoresist layer, at least one first colored varnish layer, at least one second colored varnish layer, at least one first metal layer.

21. The method according to claim 14, wherein
the at least one third colored varnish layer and/or the at least one fourth colored varnish layer, has a total ink holdout dE from the at least one layer to be structured in the CIELAB color space of from 50 to 270, and/or wherein, of the at least one third colored varnish layer, and/or of the at least one fourth colored varnish layer, and the at least one layer to be structured, the layer that faces the first replication varnish layer has a darker color, and the layer that, when viewed from the side of the plurality of microlenses arranged in the form of a grid, is arranged behind has the lighter color.

22. The method according to claim 1, wherein
the method further comprises at least one of the following steps:
generating the separate high-resolution mask by means of electron-beam lithography and/or by means of laser-beam lithography;
contact-locking joining of the separate high-resolution mask with the at least one layer to be structured applied to the carrier layer.

23. The method according to claim 1, wherein
step e) further comprises at least one of the following steps:
exposing the at least one layer to be structured to light from the side of the carrier layer opposite the plurality of microlenses arranged in the form of a grid;
aligning the separate high-resolution mask.

24. The method according to claim 1, wherein
a separate high-resolution mask with structures smaller than 10 μm, is used in step e).

25. A method for producing a multilayer body, wherein the method comprises the following steps:
a) providing a carrier layer;
b) applying a first replication varnish layer to the carrier layer;
c) molding a plurality of microlenses arranged in the form of a grid into the first replication varnish layer;
f) printing a control structure onto the side of the carrier layer opposite the plurality of microlenses arranged in the form of a grid by means of a first high-resolution digital printer;
g) detecting the control structure by means of a detection device from sides of the plurality of microlenses arranged in the form of a grid such that the control structure is detected by means of the detection device through the plurality of microlenses arranged in the form of a grid;
h) applying a printed layer in areas to the side of the carrier layer opposite the plurality of microlenses arranged in the form of a grid by means of a second high-resolution digital printer using the detected control structure such that a plurality of microimages arranged in the form of a grid are formed by the printed layer.

26. The method according to claim 25, wherein
an angular misalignment and/or a distortion is further detected in step g) with reference to the control structure.

27. The method according to claim 26, wherein
with reference to the detected angular misalignment and/or the detected distortion, the plurality of microimages arranged in the form of a grid formed of the printed layer in step h) are applied registered relative to the plurality of microlenses arranged in the form of a grid.

28. The method according to claim 25, wherein
after step h) at least one fourth metal layer and/or at least one layer made of a transparent dielectric and/or at least one fifth colored varnish layer is applied to the printed layer.

29. A method for producing a multilayer body, wherein the method comprises the following steps:
a) providing a carrier layer;
b) applying a first replication varnish layer to the carrier layer;
c) molding a plurality of microlenses arranged in the form of a grid into the first replication varnish layer;
i) applying a second replication varnish layer to the side of the carrier layer opposite the plurality of microlenses arranged in the form of a grid;
j) molding a subwavelength plasmonic structure in areas into the second replication varnish layer such that a plurality of microimages arranged in the form of a grid are formed by the molded subwavelength plasmonic structure;
k) applying a metal layer to the second replication varnish layer.

30. The method according to claim 29, wherein
in step k) the metal layer is applied such that plasmonic colors are generated by an interaction of the subwavelength plasmonic structure molded into the second replication varnish layer and the metal layer.

31. The method according to claim 29, wherein
before step i), at least one color filter layer is applied to the carrier layer.

32. The method according to claim 29, wherein
in step a), a dyed carrier layer is provided and/or a carrier layer pre-coated with an adhesion-promoter layer is provided.

33-35. (canceled)

36. The method according to claim 29, wherein
the plurality of microimages arranged in the form of a grid are formed in step e) by the areas in which the at least one layer to be structured is removed or is not removed, and/or wherein the plurality of microimages arranged in the form of a grid are formed in step h) by the areas of the printed layer in which the printed layer is applied or is not applied, and/or wherein the plurality of microimages arranged in the form of a grid are formed in step j) by the areas in which the subwavelength plasmonic structure is molded or is not molded.

37. The method according to claim 29, wherein
in step e) and/or step h) and/or step j) the plurality of microimages arranged in the form of a grid in each case consist of one or more pixels.

38. A multilayer body with a carrier layer and a first replication varnish layer, applied to the carrier layer, into which a plurality of microlenses arranged in the form of a grid are molded, and with a plurality of microimages arranged in the form of a grid arranged on the side of the carrier layer opposite the plurality of microlenses arranged in the form of a grid.

39. The multilayer body according to claim 38, wherein
the plurality of microimages arranged in the form of a grid are formed of at least one structured layer, which is removed in areas such that the plurality of microimages arranged in the form of a grid are formed.

40. The multilayer body according to claim 39, wherein
the at least one structured layer comprises or is at least one first photoresist layer.

41. The multilayer body according to claim 40, wherein
at least one structured layer further comprises at least one first colored varnish layer.

42. The multilayer body according to claim 39, wherein
the at least one structured layer further comprises or is at least one second colored varnish layer and/or at least one first metal layer and/or at least one layer made of a transparent dielectric and/or at least one thin film layer system which is arranged in particular on the side of the at least one first photoresist layer facing the plurality of microlenses arranged in the form of a grid and is arranged registration-accurately with the at least one first photoresist layer and/or which are arranged registration-accurately with each other.

43. The multilayer body according to claim 40, wherein
the structured at least one first photoresist layer further contains UV-blocking additives.

44. The multilayer body according to claim 43, wherein
the multilayer body further comprises at least one second photoresist layer and wherein the at least one second photoresist layer is arranged register-accurately next to the at least one first photoresist layer.

45. The multilayer body according to claim 44, wherein
the at least one first photoresist layer is formed of a positive photoresist, and the at least one second photoresist layer is formed of a negative photoresist.

46. The multilayer body according to claim 43, wherein
the multilayer body further comprises at least one second metal layer and/or at least one third photoresist layer, and wherein the at least one second metal layer and/or the at least one third photoresist layer is arranged registration-accurately with the at least one first and/or third photoresist layer.

47-49. (canceled)

50. The multilayer body according to claim 38, wherein
the multilayer body further comprises at least one third colored varnish layer and/or at least one partially transparent metal layer and/or at least one dielectric spacing layer.

51. The multilayer body according to claim 38, wherein
the multilayer body further comprises at least one fourth colored varnish layer and/or at least one third metal layer and/or at least one further replication varnish layer.

52. The multilayer body according to claim 51, wherein
a relief structure is stamped into the further replication varnish layer at least in areas.

53. (canceled)

54. The multilayer body according to claim 52, wherein
the plurality of microimages and microlenses arranged in the form of grids arranged overlapping at least in areas overlap with the relief structure stamped into the further replication varnish layer at least in areas, overlap with it completely or do not overlap with it.

55-56. (canceled)

57. The multilayer body according to claim 38, wherein
the layers selected from the group: at least one first photoresist layer, at least one second photoresist layer, at least one first colored varnish layer, at least one second colored varnish layer, at least one third colored varnish layer, at least one fourth colored varnish layer, at least one first metal layer and dyed carrier layer have in each case a total ink holdout dE from each other in the CIELAB color space of from 50 to 270.

58. The multilayer body according to claim 38, wherein
of the layers selected from the group: at least one first photoresist layer, at least one second photoresist layer, at least one first colored varnish layer, at least one second colored varnish layer, at least one third colored varnish layer, at least one fourth colored varnish layer, at least one first metal layer and dyed carrier layer, the layer that faces the first replication varnish layer has a darker color, and the layer that, when viewed from the side of the plurality of microlenses arranged in the form of a grid, is arranged behind has the lighter color.

59. The multilayer body according to claim 39, wherein
the at least one structured layer comprises at least two layers selected from the group: at least one first photoresist layer, at least one first colored varnish layer, at least one second colored varnish layer, at least one first metal layer.

60. The multilayer body according to claim 50, wherein
the at least one third colored varnish layer and/or the at least one fourth colored varnish layer has a total ink holdout dE from the at least one layer (14) to be structured in the CIELAB color space of from 50 to 270 and/or wherein, of the at least one third colored varnish layer and/or of the at least one fourth colored varnish layer and the at least one layer to be structured, the layer that faces the first replication varnish layer has a darker color and the layer that, when viewed from the side of the plurality of microlenses arranged in the form of a grid, is arranged behind has the lighter color.

61-63. (canceled)

64. The multilayer body according to claim 38, wherein
the at least one first and/or second and/or third photoresist layer is dyed, and/or the at least one first and/or second and/or third photoresist layer contains fluorescent substances, and/or wherein the at least one first and/or second and/or third photoresist layer is transparent.
